(19) United States
(12) Patent Application Publication
(10) Pub. No.: US 2005/0244983 A1
(43) Pub. Date: Nov. 3, 2005

(54) Method for measuring antioxidant status

(75) Inventor: Simon Yau Leung Ching, Nedlands, Western Australia (AU)

Correspondence Address: DAVIDSON, DAVIDSON & KAPPEL, LLC, 485 SEVENTH AVENUE, 14TH FLOOR, NEW YORK, NY, 10018, US

(73) Assignee: The Western Australian Centre for Pathology and Medical Research, Nedlands, Western Australia (AU)

(21) Appl. No.: 10/530,506

(22) PCT Filed: Oct. 8, 2003
(86) PCT No.: PCT/AU03/01324

§ 371 Date: Jun. 13, 2005

(30) Foreign Application Priority Data
Oct. 8, 2002 (AU) 2002951886

(51) Int. Cl. G01N 21/76

(52) U.S. Cl. 436/172; 422/61

(57) ABSTRACT

A method of measuring antioxidant status and/or the capacity to moderate oxidative stress in a sample including the step of contacting the sample with at least a fluorescing porphyrin compound and kits for measurements thereof.

### FIELD OF THE INVENTION

The present invention relates to a method for determining the antioxidant status and/or the capacity to moderate oxidative stress of inorganic and organic matter and kits for measurement thereof.

### BACKGROUND ART

Oxidative stress is a general term often used to describe the positive bias imbalance of free radicals and reactive oxygen species (ROS) in a system under stress. Oxidative stress is closely associated with antioxidants, which act as a counter balance. There is a large amount of literature available showing that antioxidants, oxidative stress, free radicals and ROS are related to many diseases. Diseases such as, aging, atherosclerosis, dementia, autoimmune diseases, and carcinogenesis, may be retarded or prevented by reducing the level of oxidative stress.

The association between diseases, oxidative stress and antioxidants as a whole remains unclear, mostly due to an inability to adequately measure antioxidant status. A question commonly asked is how many and in what amount of antioxidants does one need to reduce oxidative stress and hence reduce the incidence of preventable diseases.

The exact source of free radicals and ROS is unknown. It is suggested that biological processes such as glycolysis, the citric acid cycle, and mitochondria oxidative phosphorylabon are some of the oxidative processes, which form by-products such as HOCl, H₂O₂, HO. and O₂., and therefore contribute to oxidative stress. Monocytes, macrophages, and eosinophils, sensitised following activation, and neutrophils all generate free radicals. Endogenous nitric oxide, a free radical, has an important role as a mediator of vascular dilation, neural transmission, defence against micro-organisms and inhibition of platelet adhesion.

Extracellular free radicals may be formed when cells encounter pollutants, nitrogen oxides, toxic gases, herbicides, drugs and poisons. Stress such as vigorous exercise, heat shock, trauma, ultrasound, hyperoxia, radiation and many diseases release free radicals such as H₂O₂, HO. and O₂.⁻ from cells. Regardless of modes of formation, by-products such as HOCl, H₂O₂, HO., O₂.⁻ and NO are collectively labelled as free radicals and ROS.

Whereas intracellular free radicals and ROS may be essentially part of life, extracellular free radicals and ROS are usually formed due to environmental factors, diseases and life style such as smoking. Under oxidative stress, excess free radicals and ROS are produced by intracellular and/or extracellular means which may damage bio-molecules directly or propagate free radical chain reaction.

Free radicals and ROS are unstable, reactive and have very short half-life. Scientists have known for a long time that living organisms have different mechanisms to deal with free radicals and ROS. Antioxidants are a group of compounds used by living organisms to neutralize free radicals and ROS. The term “antioxidant status” was first used to describe the ability of a system to deal with free radicals and ROS collectively. However, so far scientists are still struggling to show clinically the beneficial protective effect of antioxidants. A number of big trials such as the Alpha-Tocopherol, Beta-Carotene Cancer Prevention Study (ATBCCPS), the Beta-Carotene and Retinol Efficacy Trial (CARET) and the Women's Health Study (WHS) cannot unequivocally state the beneficial effect of individual antioxidant against diseases.

Intracellular antioxidants consist of, for example, enzymes, proteins, peptides, and compounds such as ubiquinone, retinol and tocopherol. When the intracellular antioxidant level is low, free radicals and ROS activate oxidant-sensitive transcription factors, such as nuclear factors—₇₈β and adaptor protein, which binds to antioxidant response element (ARE) on the loci with oxidative responsive genes. This leads to synthesis of cell survival proteins such as antiapoptotic proteins Bfl-1 and Bcl-X_{L}, and antioxidant enzymes such as manganese superoxide dismutase that protect mitochondria. Increase in level of other protective enzymes and proteins such as catalase, glutathione peroxidase, glutathione reductase, glutathione-s-transferase, metallothionein, CuZn-SOD, Mn-SOD, and lipoylated-proteins have also been reported. Damage to DNA, activation of poly-ADP-ribose transferase (PADPRT) and apoptosis proceed when intracellular antioxidant level is not restored.

Extracellular antioxidants form a very diverse group of compounds and are influenced by diet and physiological states. Increased consumption of fruits, vegetable and vitamin supplements are related to an improvement in antioxidant status. Proteins such as extracellular superoxide dismutase (SOD), ceruloplasmain, ferritin, lactoferrin, transferrin, haemopexin, haptoglobin and albumin; biomolecules such as bilirubin, carotenoids (β-carotene, lycopene etc.), flavonoids (quercetin, rutin, catechin etc.), urates, ubiquinol, thiols (R-SH), vitamins A, C, and E; trace elements, such as selenium and zinc are all independent variables of antioxidant status. Low level of extracellular antioxidant may allow free radicals and ROS to react with lipid, protein and carbohydrate biomolecules on cell membrane as well as hormones and enzymes. For example, excess free radicals and ROS promote lipid peroxidation, which in turn may cause cell necrosis.

There are many different ways of measuring oxidative stress and antioxidant status including: (i) measuring free radicals and ROS directly, (ii) measuring oxidative stress by-products, (iii) measuring a combination of antioxidants, and (iv) measuring total antioxidant status.

Firstly, direct measurement of free radicals and ROS is extremely difficult because of their short half-life, instability and low concentration. For instance, HO. has a half-life of about 10⁻⁹ seconds and exists in the picomolar range. Most important of all the location at the time of formation of free radicals and ROS inside the body is unpredictable. For these reasons, methods to measure free radicals and ROS directly is impractical.

A second method for measuring antioxidant status is the measurement of oxidative by-products. Reagents used to measure some of the oxidative by-products include: 2,4-dinitrophenylhydrazine, fluorescein thiosemicarbazide and fluorescein amine/cyanoborohydride. A method to measure protein carbonyls in plasma of oxidized LDL by ELISA has also been reported. These methods require specialised expertise, are time consuming and costly and hence not widely used. In addition, the compounds being measured do not necessarily reflect the immediate picture of oxidative stress and antioxidant status.

Further, the results are subjected to misinterpretation caused by excessive non-specific production of these by-products. Alternative factors, other than systemic oxidative processes, may increase lipid peroxidation by-products such as oxidized-LDL, lipofuscin-like compounds, conjugated dienes, malondialdehyde, hydroxyalkenals, and F₂-isoprostanes. Even apparently healthy subjects show wide variation in levels of oxidative by-products in body fluids.

A third method for determining antioxidant status is to measure a combination of antioxidants. However, this approach also has its drawbacks—the major criticism being in the choice of antioxidants measured. It is plain to see the unlimited permutation possible in choosing the combination of antioxidants to measure. There are many methods available to measure intracellular and extracellular antioxidants. Methods for intracellular antioxidant are available commercially to measure enzymes such as catalase, glutathione peroxidase and superoxide dismutase, and RBC glutathione after derivatization followed by HPLC.

Total intracellular antioxidant status measurement may be difficult to perform because most of these compounds are proteins and enzymes. When it comes to extracellular antioxidants, there are a huge varieties of compounds, which may be grouped under categories such as vitamins, trace elements, thiols, enzymes, natural products, and biological molecules.

It is indeed not practical to measure each and every one of the antioxidants in vivo. It is also now widely hypothesized that the major factor influencing oxidative stress is the overall antioxidant status of the system, which prevents diseases by eliminating free radicals and ROS. Therefore, it is essential to have a method capable of measuring collectively the extracellular antioxidant status.

Finally, there are methods for measuring antioxidant status which are based on the inhibition of generated free radicals reaching the target indicator molecules, by antioxidants. The common feature for inhibition assays is to generate a free radical to react with a target molecule, thereby generating an endpoint that can be observed and quantified. Addition of antioxidants inhibits the development of this endpoint. A good example of this is the Trolox equivalent antioxidant capacity (TEAC) method based on the quenching of the absorbance of the radical cation formed by the reaction of 2,2′-azinobis(3-ethylbenzothiazoline-6-sulphonate) (ABTS) with metmyoglobin and H₂O₂.

The inhibition of the free radical action by an antioxidant in this assay depends on lag-phase and a degree of inhibition. Lag-phase in this assay is defined as the time where there is a total inhibition of peroxyl radical action by antioxidant. Some compounds show good lag-phase such as Trolox and uric acid but others like albumin show no lag phase unless at very high concentration.

There are three major problems relating to the use of lag-phase measurement in for example, body fluids. Firstly, use of lag-phase measurement assumes linear reaction rate between the peroxyl radical generator and target molecule. Secondly, body fluid with high protein content and some other compounds do not produce lag-phase at low concentrations. Thirdly, contribution to the antioxidant activity by plasma proteins such as albumin will not be included in the final results.

Another method, based on inhibition, which aims to eliminate the shortcomings of the TEAC method, has been developed. However, it also has its associated problems. This method combines both inhibition percentage and lag-phase of the free radical action by antioxidant into a single result and was named the oxygen radical absorbance (ORAC) assay. Cao GH et al., (1995) (Clin. Chem.; 41/12: 1738-44) modified the method by Glazer AN (1990) (Methods Enzymol; 186:161-168), improving it by using an area under the curve technique for quantification.

Again, there are several major draw backs with the ORAC assay. Firstly, there are chemical inconsistency and instability problems associated with the fluorescent probe molecule phycoerythrin. Phycoerythrin varies from batch to batch since it is obtained on the basis of protein content with approximately 30% protein (Lowry) and the rest primarily sucrose, dithioerythritol and sodium azide.

Secondly, the operational temperature of the ORAC assay is at 37° C. which is in direct conflict with the stability of phycoerythrin and the free radical reagent, 2,2′-azobis(2-amidinopropane) dihydrochloride in solution, both being unstable at 37° C. Phycoerythrin also suffers from photosensitivity and is highly toxic.

Thirdly, this method relies on a one-point calibration rather than the use of a more accurate standard curve. The ORAC method has been modified to replace phycoerythrin with fluorescein as the fluorescent probe. However, this assay also has to be performed at 37° C.

There are other methods in the literature recently trying different indicator and radical generating reagents, such as the method using 4,4-difluoro4-bora-3a,4a diaza-s-indacene fluorophore with 2,2′-azobis-2,4-dimethyl valeronitrile. The operational temperature of this method is also at 41° C. using a Shimadzu RF 1501 spectrofluorophotometer in a 1 cm quartz cuvette requiring stirring for 60 minutes. This method is very time consuming and cumbersome. Large-scale studies with many specimens are therefore not possible with this method.

A method known as the FRAP assay (Ferric Reducing/Antioxidant Power) measures, at low pH, reduction of a ferric tripyridyltriazine complex to the ferrous form, which has a blue colour measurable at a wavelength of 593 nm. This method has been criticised for failing to distinguish between a biological antioxidant and a chemical reductant. In addition, the FRAP assay does not measure sulphur containing compounds such as glutathione. Also, some antioxidants may not be able to reduce Fe³⁺ in vivo and Fe²⁺ is itself a pro-oxidant in vivo converting H₂O₂ to HO—.

As discussed above, there are a number of methods available in the literature for determining oxidative stress and antioxidant status. However, none of these methods are totally satisfactory for the reasons mentioned above. Therefore, there is a need to provide a method to overcome at least some of the problems associated with the methods known in the prior art.

### SUMMARY OF THE INVENTION

In one aspect, the invention is a method of measuring antioxidant status and/or the capacity to moderate oxidative stress in a sample including the step of contacting the sample with at least a fluorescent porphyrin compound.

A further aspect of the invention provides a method of measuring antioxidant status and/or the capacity to moderate oxidative stress in a sample including the step of contacting the sample with at least a fluorescent porphyrin compound, under conditions suitable for measuring the antioxidant status and/or the capacity to moderate oxidative stress in the sample.

Yet a further aspect of the invention provides a method of measuring antioxidant status and/or the capacity to moderate oxidative stress in a sample which comprises the steps of:
(a) contacting the sample with at least a free radical generating substance and a fluorescent porphyrin compound; and
(b) determining the antioxidant status and/or the capacity to moderate oxidative stress of the sample by measuring the resultant fluorescence of the mixture in step (a), and comparing the fluorescence to a standard.

In a further form of the invention a kit is provided for determining the antioxidant status and/or the capacity to moderate oxidative stress of a sample, comprising a free radical generating substance, a fluorescent porphyrin compound and instructions for their use.

### BRIEF DESCRIPTION OF THE DRAWINGS

FIG. 1 A graphical representation of the fluorescence intensity for Trolox standard at varying concentrations plotted over time.

FIG. 2 A standard curve generated by measuring the fluorescence intensity plotted over time for varying concentrations of a standard antioxidant, Trolox.

FIG. 3 The fluorescence intensity against time of the AIOR standard curves (n=64) at room temperature in 96-well plate format monitored by the Eclipse fluorescence spectrophotometer.

FIG. 4 The effect of temperature on the ORAC method of the standard curves at (a) 37° C. and (b) 25° C.

FIG. 5 The effect of temperature on the AIOR method of the standard curves at (a) 37° C. and (b) 25° C.

FIG. 6 The fluorescence intensity against time for a standard curve using (a) concentration of AAPH at 583 mM and (b) concentration of AAPH at 640 mM.

FIG. 7 AIOR standard curve for uroporphyrin at a concentration range of 0.50, 1.00, 2.00 mM.

FIG. 8 A graphical representation of the fluorescence intensity for a variety of teas plotted overtime.

FIG. 9 A graphical representation of the fluorescence intensity for a variety of coffee powders and chocolate flavoured milk powders plotted over time.

FIG. 10 A graphical representation of the fluorescence intensity for a variety of wine at a dilution of 1/10 and 1/20 plotted over time.

FIG. 11 A graphical representation of the fluorescence intensity for a variety of grape juices plotted over time.

FIG. 12 A graphical representation of the fluorescence intensity for a variety of spices plotted over time.

FIG. 13 A graphical representation of the fluorescence intensity for an antioxidant supplement plotted over time.

FIG. 14 A graphical representation of the fluorescence intensity for samples of human serum plotted over time.

FIG. 15 A graphical representation of the fluorescence intensity for uric acid plotted over time.

FIG. 16 A graphical representation of the fluorescence intensity for Vitamin C plotted over time.

FIG. 17 A graphical representation of the fluorescence intensity for Vitamin A plotted over time.

FIG. 18 A graphical representation of the fluorescence intensity for Vitamin E plotted over time.

FIG. 19 A graphical representation of the fluorescence intensity for caffeine plotted over time.

FIG. 20 A graphical representation of the fluorescence intensity for albumin plotted overtime.

FIG. 21 A graphical representation of the fluorescence intensity for total protein plotted over time.

FIG. 22 A graphical representation of the fluorescence intensity for polyphenol plotted over time.

### DISCLOSURE OF THE INVENTION

General

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in the specification, individually or collectively, and any and all combinations or any two or more of the steps or features.

The present invention is not to be limited in scope by the specific embodiments described herein, which are intended for the purpose of exemplification only. Functionally equivalent products, compositions and methods are clearly within the scope of the invention as described herein.

The entire disclosures of all publications (including patents, patent applications, journal articles, laboratory manuals, books, or other documents) cited herein are hereby incorporated by reference. No admission is made that any of the references constitute prior art or are part of the common general knowledge of those working in the field to which this.invention relates.

As used herein the term “derived” and “derived from” shall be taken to indicate that a specific integer may be obtained from a particular source albeit not necessarily directly from that source.

Throughout this specification, unless the context requires otherwise, the word “comprise”, or variations such as “comprises” or “comprising”, will be understood to imply the inclusion of a stated integer or group of integers but not the exclusion of any other integer or group of integers.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

Description

The present invention provides a simple and reliable method for the measurement of the antioxidant status and/or the capacity to moderate oxidative stress of inorganic and organic matter. In particular, the method of the present invention incorporates a new type of fluorescent probe for the measurement of extracellular or intracellular antioxidant status. This method has been named the antioxidant inhibition of radical assay or AIOR assay.

Antioxidant status generally relates to the chemical properties of inorganic or organic matter capable of inhibiting reactions promoted by free radical generating substances. That is, matter with a higher ability to inhibit free radicals would have a higher antioxidant status compared to matter that has a lower ability to inhibit free radicals.

The capacity to moderate oxidative stress generally relates to the capability of matters to reduce the cumulative physiological damage done on the body that is caused by the free radicals.

In one aspect, the present invention provides a method of measuring antioxidant status and/or the capacity to moderate oxidative stress in a sample including the step of contacting the sample with at least a fluorescent porphyrin compound.

In one preferred embodiment the method of the present invention is used to measure intracellular antioxidant status, such as extracts of cell culture and cell homogenates. The intracellular antioxidant status may, however, vary depending on the adequacy of the cellular response mechanisms present. In addition, many of the intracellular antioxidants are enzymes, which are not measured by this method. In an alternate preferred embodiment, the extracellular antioxidant status is measured.

In a further embodiment, the invention provides a method of measuring antioxidant status and/or the capacity to moderate oxidative stress in a sample including the step of contacting the sample with at least a fluorescent porphyrin compound, under conditions suitable for measuring the antioxidant status and/or the capacity to moderate oxidative stress in the sample.

In an even more preferred embodiment, the method of measuring antioxidant status and/or the capacity to moderate oxidative stress in a sample comprises the steps of:
(a) contacting the sample with at least a free radical generating substance and a fluorescent porphyrin compound, and
(b) determining the antioxidant status and/or the capacity to moderate oxidative stress of the sample by measuring the resultant fluorescence of the mixture in step (a), and comparing the fluorescence to a standard.

The method of the present invention generates an endpoint with a free radical generating reagent that can be quantified. Briefly, the presence of antioxidants in a sample inhibits the breakdown of the fluorescent porphyrin by the free radical generating reagent. The resulting change in fluorescence provides a measure of the amount of antioxidant present in a sample. That is, the more antioxidants present in a sample, the slower the rate of degradation of the porphyrin probe.

Porphyrins form a diverse group of compounds. By way of example only, certain substituted porphyrin structures that may be used include the trivially named uroporphyrin I, uroporphyrin II, uroporphyrin III, and uroporphyrin IV; coproporphyrin I, coproporphyrin II, coproporphyrin III, and coproporphyrin IV; MS-tetraphenylporphyrin; deuteroporphyrin IX; hematoporphyrin IX; mesoporphyrin; protoporphyrin IX; dihydrochloride and methyl ester derivatives of all the above mentioned porphyrins.

In a highly preferred embodiment, the probe is of a uroporphyrin structure. More preferably, the probe is uroporphyrin I dihydrochloride.

The fluorescence intensity (a.u.) is directly proportional to the concentration of the final working solution of porphyrin. For example, a stock solution of porphyrin may be prepared and diluted. The effect of diluting the stock solution is a lowering of the mean fluorescence intensity. Fluorescence intensity reading of the porphyrin solution may also be adjusted by altering the PMT voltage. For example, a 10% increase in the PMT voltage compensates for an increase in dilution of the porphyrin solution and an improvement in the mean fluorescence intensity.

The concentration of porphyrin used in the method of the present invention varies depending on a number of factors. One factor affecting the concentration of the porphyrin solution used in the method of the present invention is the millimolar absorption coefficient ε_{mM} (mmol⁻¹ cm⁻¹) of the particular porphyrin used. That is, if the ε_{mM} for the porphyrin is regarded as high, the concentration of the porphyrin solution used will be lower than porphyrins with a lower ε_{mM}.

In a highly preferred embodiment, a stock solution of uroporphyrin (225 uM) is prepared. The stock solution may then be diluted prior to use in the method. For example, the stock solution may be diluted 1/500 (0.450 uM), 1/750 (0.300 uM) or 1/1000 (0.225 uM).

A further factor affecting the concentration of porphyrin used is the type of equipment used to measure the resulting fluorescence signal. For example, a sensitive spectrofluorometer may require a lower concentration of porphyrin solution than a less sensitive model.

An additional factor affecting the shape of the curve of the present invention is the ratio of sample to free radical generating system to porphyrin. In a highly preferred embodiment, for example the ratio of sample to free radical generating system to porphyrin in the 96-well plate format (μL) may be 1:22:136, or 2:30:186.

Another factor affecting the concentration of porphyrin solution used in the method of the present invention is the volume of the sample container required by the equipment used to measure the fluorescence signal. For example, larger sample containers, such as 1 cm cuvettes, require a relatively low concentration of porphyrin solution. In one embodiment, a concentration of 90 nmol/L of uroporphyrin I dihydrochloride was sufficient to generate a measurable fluorescence signal. In a further embodiment, a 96-well plate was used in the method of the present invention, and a concentration range of about 180 nmol/L to about 300 nmol/L was used. A higher concentration range may be required for plates with 384 wells.

A person skilled in the art would be able to determine the appropriate concentration of porphyrin solution required for use of the present invention with a spectrofluorometer capable of measuring fluorescence signal.

Porphyrins are soluble in a range of solvents. For example, porphyrins are soluble in water, chloroform, pyridine, cyclohexanone, benzene, dioxane and p-dioxane. Less ionic porphyrins (e.g. esterified derivatives) tend to be more soluble in dioxane or chloroform.

For example, dihydrochloride derivatives of uroporphyrin I, II, III, IV, and coproporphyrin I, II, III and IV, dihydrochloride derivatives of hematoporphyrin IX, uroporphyrin I, II, III, IV, and coproporphyrin I, II, III and IV, mesoporphyrin and protoporphyrin IX are soluble in aqueous solution.

Further, methyl ester derivatives of uroporphyrin I, II, III and IV and coproporphyrin I, II, III and IV, deuteroporphyrin IX dimethyl ester, hematoporphyrin IX dimethyl ester, mesoporphyrin dimethyl ester and protoporphyrin IX dimethyl ester are soluble in chloroform.

In addition, uroporphyrin II octamethyl ester is soluble in pyridine. Uroporphyrin III is soluble in cyclohexanone. MS-tetraphenylporphyrin is soluble in benzene. Coproporphyrin I Tetramethyl ester, Coproporphyrin II Tetramethyl ester derivatives of coproporphyrin I, II, III and IV and deuteroporphyrin IX dimethyl ester are soluble in dioxane. Finally, mesoporphyrin dimethyl ester and protoporphyrin IX dimethyl ester are soluble in p-dioxane.

For measuring the antioxidant status and/or capacity to moderate oxidative stress in biological systems using the method of the present invention, the porphyrins are preferably soluble in an aqueous solution. Some porphyrins which are more soluble in organic solvents, such as dioxane, are more suitable for measuring hydrophobic antioxidants, such as Vitamin A and some lipids. However, it is important to test the solvent for antioxidant activity before use in the AIOR assay.

The porphyrins used in the method of the present invention are preferably relatively stable at room temperature. That is, the probe(s) used in the present method are less temperature dependent than the probes used in other fluorescent methods. This allows for the reaction of the present invention to be carried out at room temperature. Specialised equipment for heating and problems associated with diffusion of heat and the effects of temperature on reagent reactivity and stability are therefore not important considerations to be taken into account. Any free radical generating reagent known to those skilled in the art may be used. By way of example, free radical generating reagents include peroxidase/H₂O₂, horseradish peroxidase/H₂O₂ and Cu²⁺/H₂O₂. In a highly preferred embodiment, the free radical generating reagent is 2,2′-azobis(2-methylpropionamidine) dihydrochloride (AAPH).

Other water-soluble “amidino-azo radical initiators” such as 2,2′-azobis(2,4-dimethylvaleronitrile), 2,2′-azobis[2-(2-imidazolin-2-yl)-propane], and 2,2′-axobis{2-[2-(4-methyl)imidazolin-2yl]-propane}, which generate alkylperoxyl and/or alkoxyl radicals, are also likely to be suitable for the AIOR assay.

Other compounds may be incorporated into the method for the purpose of enhancing the reproducibility and accuracy of measuring the antioxidant status and/or the capacity to moderate oxidative stress of various types of inorganic and organic matters.

For example, to measure the antioxidant status and/or to measure the capacity to moderate oxidative stress, of a sample containing both hydrophobic and hydrophilic antioxidants, it is often necessary to include for example, surfactants, emulsifiers or solubilisers. In a preferred embodiment, the surfactant belongs to the polyoxyethylene alcohols group. Other names for this group of compounds include polyethylene glycol fatty alcohol ethers; ethoxylated fatty alcohols; macrogol fatty alcohol ethers; alcohol ethoxylates; polyoxyethylene alcohol ethers or polyoxyethylene ethers.

The above compounds are nonionic surfactants prepared by ethoxylation of fatty alcohols with ethylene oxide. Many of these compounds are known by their Trademark. For example, some commercially available series of compounds include: Alfonic, Bio Soft EA, Brij 35™, Dehydol, Emulphogene, Ethosperse, Eumulgin, Ethoxyol, Lipal, Lipocol, Macol, Polychol, Siponic, Trycol, and Volpo.

In a highly preferred embodiment, the surfactant is polyoxyethylene ethers, such as Brij 35™. In a more highly preferred embodiment, Brij 35 is added to the working solution of porphyrin solution in a concentration of about 30% (w/v).

The method of the present invention is adaptable to high throughout methods. This type of sample analysis may be achieved for several reasons. Firstly, the stability of the fluorescent probe at room temperature allows for a large number of samples to be measured at one time. For example, the fluorescent probe reagent may be delivered to the wells of a 96-well plate and not be effected by the delay between mixing of reagents and sample and the time of reading.

Secondly, the method of the present invention is suitable for scaling down to a micro-assay technique. Therefore, the volume of sample and reagents required is minimal.

Finally, the reagents used in the method of the present invention are not costly and readily available, thus allows the analysis of many samples.

The degradation of the porphyrin probe is measured using fluorometry. Any type of fluorometer capable of measuring fluorescence may be used. For example, any spectrofluorometer capable of holding a cuvette or a 96-well plate may be used. In a highly preferred embodiment, the Varian Cary Eclipse fluorescence spectrophotometer, which is capable of reading 96-well plate, may be used to measure the change in fluorescence. The Varian Cary Eclipse fluorescence spectrophotometer monitors each of the 96-well plate spectra with individual window in real time and also provides automatic data analysis and processing. With the Varian Cary Eclipse fluorescence spectrophotometer, there is the option for expansion from 96- to 384-well plate format which enables large throughput of samples.

The method of the present invention takes into account the lag-phase and degree of inhibition of a wide rarige of antioxidants by monitoring the reaction between the antioxidant, probe and free radical generating substance for a period of time, rather than a single point in time measurement. The area under the curve for the duration of the entire assay is integrated and the value compared to a standard curve to determine the concentration of antioxidant. The standard curve is produced using a known amount of an antioxidant. Suitable antioxidants for generating a standard curve include Trolox, Vitamin C and Gallic acid.

In a highly preferred embodiment of the Invention, the samples, blank and standards (1 uL) are added to the wells of a plate. The working solution of fluorescent porphyrin is then added and mixed. A solution of free radical generating reagent is then added to each well, mixed and the change in fluorescence monitored over a period of time of approximately 180 minutes. The area under the curve is determined using computer software appropriate for the instrument used to monitor the change in fluorescence over time (such as GraphPad Prism 4.0 software, GradPad Software, Inc., San Diego Calif., 2003). The resulting measurement may be expressed as an equivalent to a known concentration of a standard solution of antioxidant. Trolox may be used, for example, as an antioxidant standard. That is, the antioxidant status or capacity to moderate oxidative stress may be expressed as a Trolox equivalent.

The choice of the type of plate used in a fluorescence spectrophotometer is an independent factor relevant to the good performance of the AIOR assay. Plates may be made of glass, polystyrene or polypropylene. Polystyrene plates are also available in a variety of colours, including black, transparent or white. In addition, the plates have a different shape at the bottom of the well including flat, v-shaped or round bottom. The type of material from which the plate is made and the shape of the well may influence the fluorescence intensity and result is an altered sensitivity of the assay.

The method of the present invention may be used to measure antioxidant status and/or the capacity to moderate oxidative stress of various inorganic and organic matter. For example, the antioxidant status may be assessed in food items, such as fruit, vegetables, meats, dairy products, cereals, grains, food additives, seafood, traditional herbal medicine, vitamins, preserved fruit and vegetables and natural plant extracts; beverages, such as tea, coffee, chocolate flavoured powders, soft drinks, wine, beer, or fruit juice; and biological compounds, such as thiols and lipids. In addition, the antioxidant status and/or the capacity to moderate oxidative stress of various inorganic and organic matter of biological fluids, such as blood and urine, may also be assessed using the method of the present invention.

The method of the present invention may be used to measure the antioxidant status of various inorganic and organic matters. For example, in a highly specific embodiment, a sample of inorganic or organic matter is contacted with a fluorescent porphyrin compound in the presence of a free radical generating substance. The presence of antioxidants in the sample inhibits the breakdown of the fluorescent porphyrin by the free radical generating substance. The resulting change in fluorescence is monitored and provides a measure of the amount of antioxidant present in the sample. A standard curve of a known concentration of an antioxidant (such as Trolox) may be used to compare the antioxidant status of inorganic or organic matter.

The method of the present invention may also be used to measure the capacity to moderate oxidative stress of various inorganic or organic matter. For example, a sample of inorganic or organic matter is contacted with a fluorescent porphyrin compound in the presence of a free radical generating substance. The presence of antioxidants in the sample inhibits the breakdown of the fluorescent porphyrin by the free radical generating substance. The resulting change in fluorescence provides a measure of the amount of antioxidant present in the sample. The capacity of inorganic or organic matter can then be determined by comparing to a known amount of antioxidant, such as Trolox. The greater the concentration of Trolox (antioxidant) the greater the capacity to moderate oxidative stress. Therefore, matter with a high Trolox equivalent will have a greater capacity to moderate oxidative stress than matter with a lower Trolox equivalent.

The antioxidant status of samples, such as biological fluids may be measured to assess the health risk of an individual. In addition, the antioxidant status may be used directly or indirectly in the treatment of diseases such aging, atherosclerosis, dementia, autoimmune diseases, and carcinogenesis. If the antioxidant status of an individual is known, it may then be possible to provide suitable treatment, since many diseases may be prevented or retarded by reducing the level of oxidative stress.

Further uses of knowing the antioxidant status of inorganic or organic matter include: verifying the antioxidant status in foods, drinks and supplements as claimed by the manufacturer; quality control of antioxidants in substances such as tea, coffee, wine and other food items; accurately measuring the antioxidant status of a drug which may aid in the development of antioxidant drugs for the treatment of disease.

In another aspect of the invention, there is provided a kit for determining the antioxidant status and/or the capacity to moderate oxidative stress of a sample, comprising a free radical generating substance, a fluorescent porphyrin compound and instructions for their use.

### Best Mode(s) for Carrying Out the Invention

Chemicals and Equipment

2,2′-azobis(2-amidinopropane) dihydrochloride (AAPH), (±)6-hydroxy-2,5,7,8-tetramethylchromane-2-carboxylic acid (Trolox), Brij 35 solution and uroporphyrin I dihydrochloride were obtained from Sigma Aldrich (Castle Hill, NSW, Australia).

All standards and samples were analysed on the Cary Eclipse fluorescence spectrophotometer (Varian Australia Pty Ltd, Mulgrave, Victoria, Australia). Standard and sample analysis was carried out in 96-well round bottom polypropylene microplates with a capacity of 330 μL, purchased from Alltech Associates Australia (Baulkham Hills, NSW, Australia). A 1296-001 plateshaker was used (LKB-Wallac (Heidolph, Schwabach, German) to mix the standards/samples with the reagents.

The stock phosphate buffer (0.75 M, pH 7.0) was prepared by mixing 61.1:38.9 (v/v) of a 0.75 M K₂HPO₄ and a 0.75 M NaH₂PO₄ solution. The working phosphate buffer 75 mM, pH 7.0 was prepared by a 1:9 (v/v) dilution of the 0.75 M stock phosphate buffer.

AAPH (583 mM) was prepared by dissolving completely 0.474 g of AAPH in 3 mL of 75 mM, pH 7.0 phosphate buffer. This solution was prepared freshly before each run.

Uroporphyrin stock solution (225 μM) was prepared by dissolving 1.2 mg of uroporphyrin I dihydrochloride in 5.9 mL of phosphate buffer (75 mM, pH 7.0). This solution was very stable for many months by storing in the dark at 4° C. A secondary uroporphyrin stock solution for routine use was prepared by a 1:50 (v/v) dilution of the stock uroporphyrin solution with phosphate buffer (75 mM, pH 7.0). This secondary stock solution was stable for several months in the dark at 4° C. A working uroporphyrin solution for daily use was prepared by a 1:750 (v/v) dilution of the secondary uroporphyrin solution with phosphate buffer (75 mM, pH 7.0).

To enable complete solubility of both hydrophobic and hydrophilic compounds in the sample, a surfactant Brij 35™ was added to the working uroporphyrin solution in the quantity of 0.1% of the reagent.

Trolox was used as an antioxidant standard to compare the antioxidant status of various inorganic and organic matter. A stock Trolox standard solution (5.0 mM) was prepared by dissolving Trolox 35 (250 mg) in 200 mL of phosphate buffer (75 mM, pH 7.0). Working standards of Trolox were prepared by diluting the stock Trolox standard to 0.5, 1.0 and 2.0 mM with the same buffer.

Method of Measuring Antioxidant Status and Determining the Capacity to Moderate Oxidative Stress

Sample/blank/standard (1 μL), and working uroporphyrin solution (0.300 uM) with Brij™ (136 μL) were added to the wells of a 96-well microplate. Blank, standards or diluted samples were added first into the well, followed by working uroporphyrin solution with Brij™. The contents of each well was mixed using a plateshaker for 1-2 minutes. Freshly prepared AAPH solution (583 uM) (22 μL) was then added. This procedure provided a sample to AAPH to uroporphyrin ratio of (1:22:136). The contents of the wells were then mixed again for exactly 2 minutes before acquisition of data with the Varian Cary Eclipse fluorescence spectrophotometer. A sample to reagent ratio of (2:30:186) was also used to further improve the precision of the assay.

Fluorescence Monitoring and Data Processing:

The Varian Cary Eclipse fluorescence spectrophotometer settings were as follows.
Excitation λ=397 nm; Emission λ=615 nm.
Excitation Slit=20 nm; Emission Slit=10 nm.
Ave Time=0.2 sec.
Run Time=180 minutes.
Y (min-max)=0-1000.
Excitation Filter: Auto.
Emission Filter: Open.
PMT: Variable (Choice of low, medium or high).

The method takes the free radical action to completion in 180 minutes. The Varian Cary Eclipse fluorescence spectrophotometer has the ability to achieve high throughput of 96 samples in 180 minutes with the 96-wellplate format. Both time and cost of this assay per sample is greatly reduced by this method. This invention provides both a method and reagent, which can accurately, easily, economically, and quickly analyze antioxidant status.

Data Processing

The results of the analysis were normalized by Varian Cary Eclipse software and calculated by GraphPad Prism 4.0 software (GraphPad Software, Inc., San Diego Calif., 2003).

Results

Uroporphyrin absorbs light in solution at a wavelength of 406 nm in 1 M HCl and has a maximum millimolar absorption coefficient (ε_{mM}) of 505. In a 0.5 M HCl solution, uroporphyrin absorbs light at 406 nm with an absorption coefficient (ε_{mM}) of 541. Free radicals and ROS breakdown uroporphyrin thereby resulting in a degradation of the fluorescence intensity over time. However, the presence of antioxidants in the sample or standard solution prevents the degradation of fluorescence. Therefore, fluorescence intensity maintained over time is an indication of a higher concentration of antioxidants. That is, the longer the fluorescence intensity is maintained the greater the amount of antioxidants present in the sample.

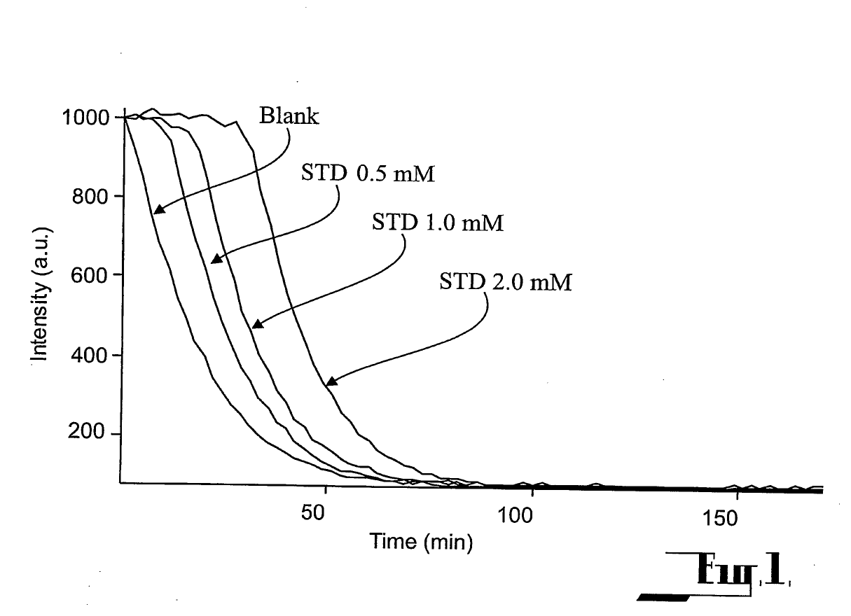

FIG. 1 shows the result of the fluorescence intensity of standard solutions of Trolox (0 to 2.0 mM) measured over time. As can be seen from the graph, a standard solution of 2 mM Trolox maintains a fluorescence intensity for a longer time than standard solutions of Trolox at 0 to 1.0 mM.

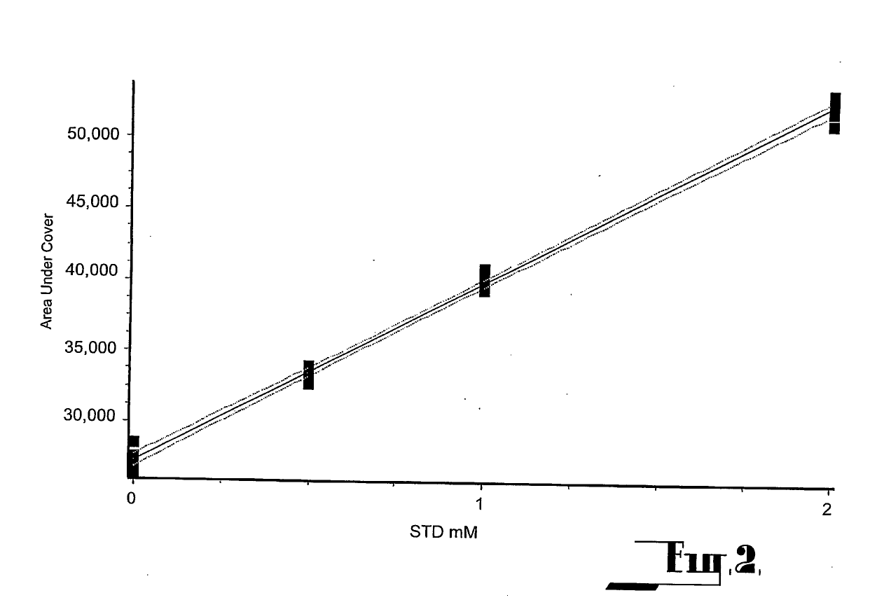

The results of the above experiment were plotted as fluorescence intensity versus concentration of Trolox, as shown in FIG. 2. The result is a linear standard curve from at least 0.5 mM to at least 2.0 mM.

Precision of the AIOR Assay

To demonstrate the precision of the AIOR assay, the Trolox standard curve was performed 16 times in the same run. The precision of this assay was shown to be excellent. The results showed that the intra-assay precision of the standard curves (n=16) have a coefficient of variation (CV) of <5% for the blank and CV of <3% for all the standards as shown in Table 1 below.

TABLE 1

| Trolox | Mean Area | | CV | |
|---|---|---|---|---|
| Concentration | Under Curve | SD | (%) | n |
| Blank | 37362 | 1721 | 4.6 | 16 |
| 0.5 mM | 47456 | 991 | 2.1 | 16 |
| 1.0 mM | 57535 | 1368 | 2.4 | 16 |
| 2.0 mM | 76499 | 1850 | 2.4 | 16 |

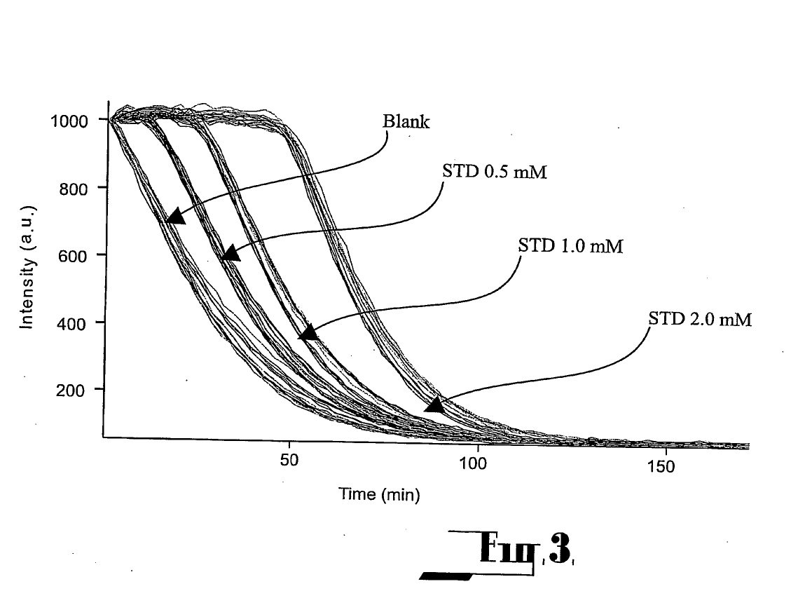

FIG. 3 shows the fluorescence intensity against time of the AIOR method for Trolox standard curves (n=64) at room temperature in 96-well plate format monitored by the Eclipse fluorescence spectrophotometer.

AIOR Method Development

Effect of Temperature

A comparison of the effect of temperature between the Oxygen Radical Absorbance (ORAC) assay using phycoerythrin and the AIOR method using uroporphyrin is described below.

Both the ORAC and the AIOR method are based on inhibition of free radicals by antioxidants against a specific class of indicator molecules. The indicator molecule for the ORAC method is phycoerythrin, and for the AIOR method is uroporphyrin I. Antioxidants inhibit the destruction of these fluorescence compounds by free radicals introduced into the assay and it is important to monitor these reactions over a period of time. Both of these methods are designed to measure the total antioxidant capacity in a solution. Methods that only measure a single time point of the reaction disregard the different reactivity of antioxidants to free radicals. However, in the ORAC and AIOR methods, both monitor the intensity of the fluorescence (a.u.) over time. By integrating the area under the curve for the length of the reaction, variable factors such as lag time and reaction time are taken into consideration.

However, the major difference between the AIOR method and other methods, including the ORAC assay, is the independence from the effect of temperature. That is, the AIOR method does not need to be incubated at 37° C. whereas the ORAC and related methods must be carried out at 37° C. to obtain consistent results.

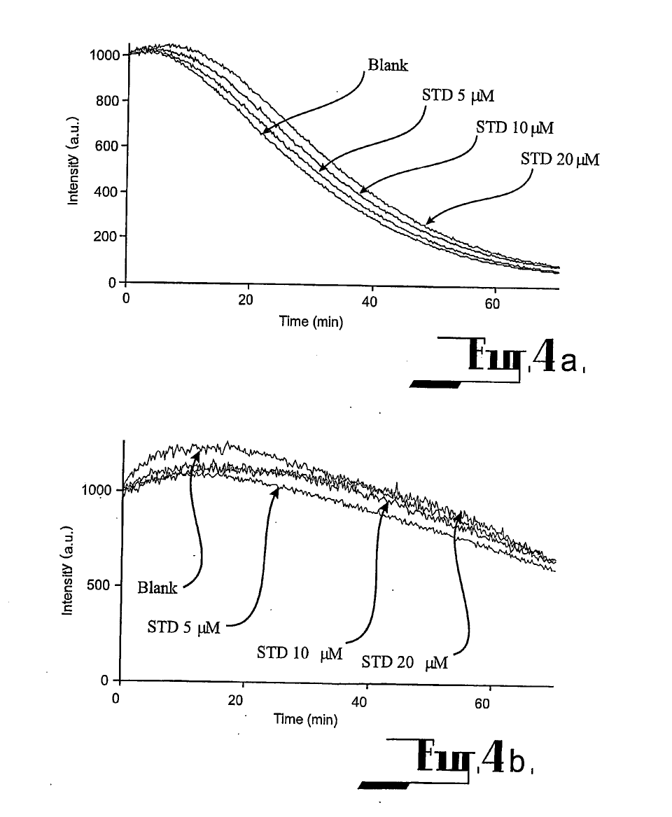

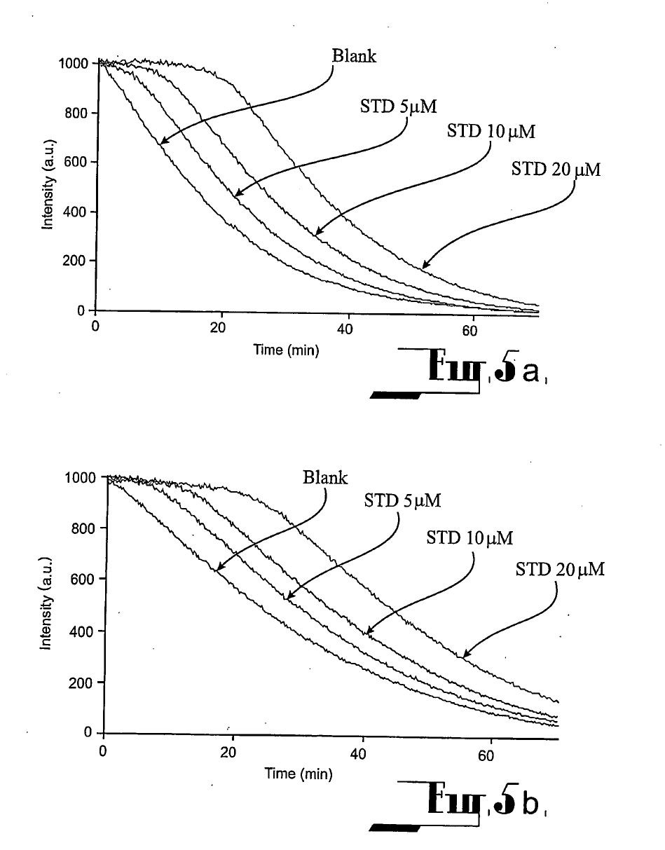

Both methods were performed in cuveftes at 37° C. and at room temperature (25° C.). FIG. 4 shows the effect of temperature on the ORAC method of the standard curves at 37° C. and 25° C. The ORAC method was shown to be very ineffective at 25° C. In contrast, the AIOR method showed no effect of temperature dependency on the standard curves in both temperatures at 37° C. and 25° C. (FIG. 5).

One of the benefits of performing the method at room temperature is the elimination of the requirement for temperature control imposed on fluorescence spectrophotometers for the measurement of total antioxidant capacity. In addition, antioxidants in the samples and the free radicals generating reagent are more stable at room temperature than at 37° C.

Fluorescence measurement is dependent on many factors, regardless of the instrumentation used, and there are a number of factors that need careful consideration, such as turbidity, bubbles in the sample, pH and photochemical decay of the indicator compound. Fluorescence is also affected by changes in temperature. As temperature increases, fluorescence decreases. The AIOR assay is performed at room temperature and as a result is far more stable and reliable than all the existing methods in the literature, which requires heating and maintaining at 37° C. for their assays.

The Effect of the Concentration of AAPH

The effect of the concentration of 2,2′azobis(2-methylpropionamidine) dihydrochloride (AAPH) on the AIOR assay was investigated. The concentration of AAPH is a dependent factor in determining the shape of the area under the curve. To find the most appropriate concentration of AAPH for this assay, two different concentrations of AAPH were investigated. A working uroporphyrin reagent solution of 1/1000 (0.225 uM) with blank and Trolox standards of 1.0, 2.0, 4.0 mM was used to determine the shape of the area under the curve for two AAPH concentrations at 583 and 640 mM. The sample to AAPH: uroporphyrin ratio was 1:45:280 of sample: AAPH. The two tailed P values showed that there was significant difference between the two AAPH concentrations in the mean area under the curve for both blank and standards as shown in Table 2. The higher concentration of AAPH gave a smaller area under the curve for the standards. It is important to use an effective concentration of AAPH for the AIOR assay to obtain the best shape for the area under the curve.

TABLE 2

| | Area Under Curve (mean ± SD) | | | | |
|---|---|---|---|---|---|
| AAPH (mM) | Blank | STD 1.0 mM | STD 2.0 mM | STD 4.0 mM | n |
| 583 | 16378 ± 762 | 40829 ± 4000 | 55416 ± 3207 | 77238 ± 3701 | 6 |
| 640 | 20998 ± 1558 | 35554 ± 2267 | 44522 ± 2348 | 69220 ± 6603 | 6 |
| Two tailed P value | <0.0001 | <0.02 | <0.0001 | <0.03 | — |

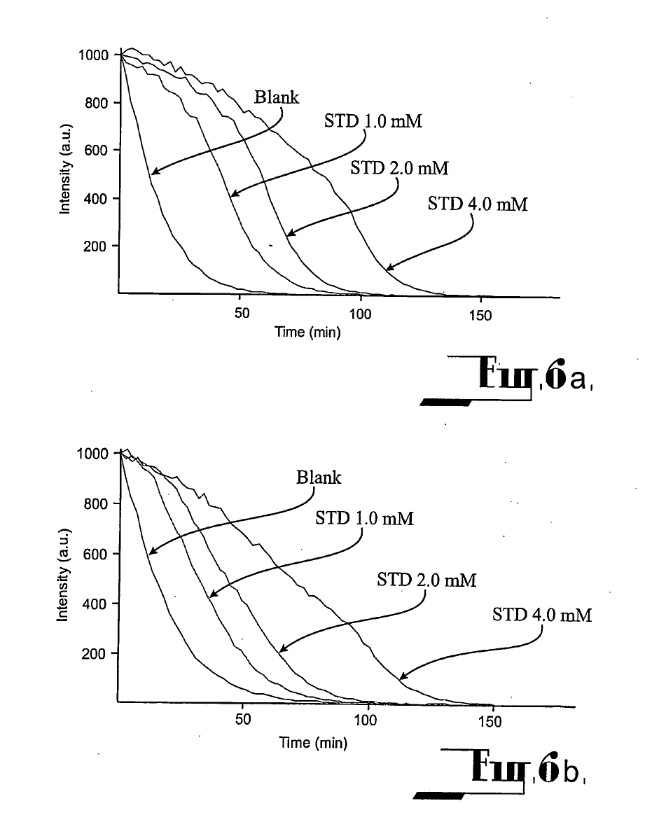

FIGS. 6(a) and 6(b) show the fluorescence intensity against time for the standard curves under the same conditions using two different concentrations of AAPH (583 mM and 640 mM, respectively). The Graphs clearly indicated that the area under the curve is greater with the less concentrated AAPH solution.

AAPH generates peroxyl radical for the AIOR assay. Therefore, the reagent must be prepared freshly and immediately before use. To ensure reproducibility, the AAPH must be completely dissolved in solution. In addition, the volume of AAPH also alters the area under the curve, thus consideration must also be given to the reagent to sample ratio.

Effect of Uroporphyrin Concentration on AIOR Assay

The concentration of uroporphyrin is another important dependent factor that controls the fluorescence intensity of the reaction and the shape of the curve. Fluorescence intensity (a.u.) is directly proportional to the concentration of the final working uroporphyrin solution. The concentration of the stock uroporphyrin solution used for this method was 225 μM. Stock uroporphyrin solution diluted from a range of 1/750 dilution (0.300 uM) to 1/1000 dilution (0.225 uM) has the effect of lowering the mean fluorescence intensity from 644 a.u. to 400 a.u.. Fluorescence intensity reading may also be adjusted higher or lower by altering the PMT voltage. A 10% increase in the voltage approximately doubles the fluorescence intensity. Increase in the PMT voltage from 600 to 650 volts compensated for the increase in dilution from 1/500 to 1/750 and improved the mean fluorescence Intensity from 508 a.u. to 644 a.u. as shown in Table 3.

TABLE 3

| Working | Reagent | PMT | Mean | | |
|---|---|---|---|---|---|
| Uroporphyrin | Volume | Voltage | Fluorescence | | |
| Dilution | (μL) | (V) | (a.u.) | SD | n |
| 1/500 | 280 | 600 | 508 | 10 | 60 |
| 1/750 | 280 | 650 | 644 | 28 | 60 |
| 1/1000 | 280 | 650 | 400 | 17 | 60 |

The fluorescence intensity is also directly proportional to the volume of the working uroporphyrin reagent in the 96-well plate. Using the same working uroporphyrin dilution of 1/750, reducing the reagent volume from 280 to 136 μL 5 also decreased the mean fluorescence intensity from 644 to 171 a.u. as measured by the Varian Eclipse fluorescence spectrophotometer at the same PMT voltage of 650 V.

Performance of individual fluorescence spectrophotometer is different because fluorescence varies between fluorescence spectrophotometer. Independent factors influencing the performance of the fluorescence spectrophotometer are the alignment of the 96-well plate, the sensitivity of the PMT, and the age of the lamp of the instrument. Comparison of two Varian Eclipse instruments using the same conditions gave significantly different mean fluorescence intensity of 171 and 466 a.u. respectively (see Table 4).

TABLE 4

| | Working | Reagent | PMT | Mean | | |
|---|---|---|---|---|---|---|
| Varian | Uroporphyrin | Volume | Voltage | Fluorescence | | |
| Eclipse | Dilution | (μL) | (V) | (a.u.) | SD | n |
| I | 1/750 | 136 | 650 | 171 | 7 | 60 |
| II | 1/750 | 136 | 650 | 466 | 25 | 60 |

Comparison of Range of Standard Solutions of Uroporphyrin

The three dependent factors, which influenced the area under the curve so far discussed, are the sample to reagent ratio, the concentration of working uroporphyrin solution and the concentration of AAPH solution. However, when it comes to standard range, users of the AIOR method, have the choice. The decision of which standard range to use is mainly influenced by the concentration of the antioxidants to be measured.

A range of Trolox standards from (0.01 to 0.04 mM) to (1.25 to 5.00 mM) were compared for linearity as shown in Table 5. All standard ranges showed good linear relationship of area under the curve to standard concentrations. It is worth noting that at the lower end of the standard range, from 0.01 mM to 0.04 mM, the precision was not as good as the higher end of the standard range, such as from 0.5 mM to 2.0 mM. The use of smaller or larger total reaction volume did not affect the linearity of the standard range.

TABLE 5

| | Uropor- | | | |
|---|---|---|---|---|
| | phyrin | AAPH | Sample:Reagent | FIGURE |
| Standards (mM) | Dilution | (mM) | Ratio (μL) | Number |
| 1.25, 2.50, 5.00 | 1/1000 | 640 | 1:45:280 | 8 (a) |
| 1.00, 2.00, 4.00 | 1/1000 | 640 | 1:45:280 | 8 (b) |
| 0.50, 1.00, 2.00 | 1/750 | 583 | 2:40:270 | 9 (a) |
| 0.50, 1.00, 2.00 | 1/750 | 583 | 2:28:170 | 9 (b) |
| 0.50, 1.00, 2.00 | 1/750 | 583 | 1:22:136 | 10 (a) |
| 0.01, 0.02, 0.04 | 1/1250 | 320 | 20:25:280 | 10 (b) |

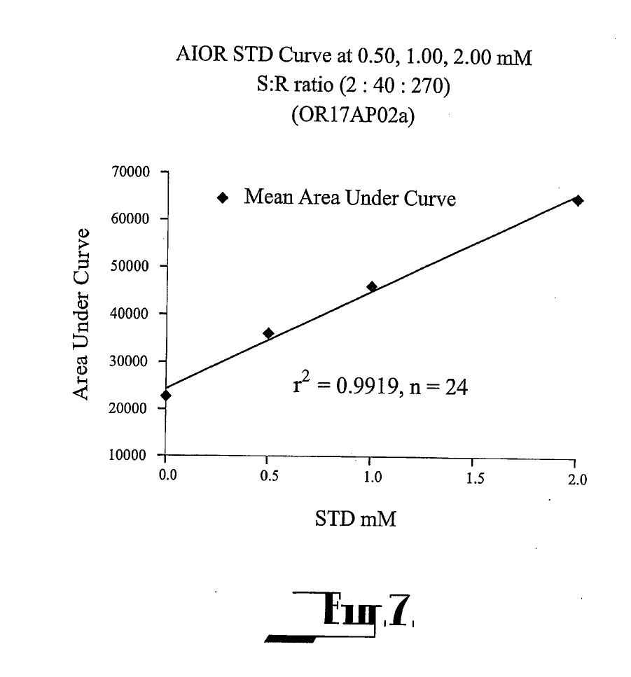

The choice of which standard range to use is optional and is dependent on the concentration of the samples to be measured. The Trolox standard range of 0.5, 1.0, and 2.0 mM was chosen for most of the experiments to determine antioxidants. FIG. 7 is a representative example of the AIOR standard curve at a concentration of 0.50, 1.00, and 2.00 mM. This range, for example, enabled samples tested to be diluted within an appropriate range, such as, 1/6 for serum and 1/15 for red and white wine.

The polypropylene round bottom 96-well plate has a maximum capacity of 330 μL. A reaction volume of 159 μL with a sample to AAPH: uroporphyrin ratio of (1:22:136) μL was found to be a good volume for measurement and mixing without spillage on the plate-shaker. For higher intensity, the reagent ratio of (2:30:186) μL was also used.

Solubility

An independent factor, which improves the precision of the AIOR assay, is the addition of a polyoxyethylene alcohol, such as Brij 35. Given the diversity of compounds the AIOR method has to accommodate, it is important that all compounds both hydrophobic and hydrophilic are in a suitable environment for the reaction. To create an environment suitable for both hydrophilic and a hydrophobic compounds, Brij 35 (30% w/v) was added into the working uroporphyrin solution. The results show considerable improvement in the precision and sensitivity of the AIOR assay.

As a result of the addition of a polyoxyethylene alcohol, all compounds and substances measured with this method may be dissolved in either aqueous or organic solvents. The effect of solvents on the method were studied and the results are expressed as a Trolox equivalent (Table 6). The aqueous solvents used in these experiments are water and phosphate buffer 75 mM at pH=7.0. Organic solvents often used in this assay are ethanol and isopropanol. In these experiments, the area under the curve of the solvents was compared against that of the blank.

TABLE 6

| Antioxidant status in mM | | | | |
|---|---|---|---|---|
| Trolox equivalent | Ethanol | Isopropanol | DMSO | Acetone |
| Low value | 0.0 | 0.0 | 0.6 | 0.0 |
| High value | 0.1 | 0.1 | 1.2 | 0.2 |
| Mean value | 0.08 | 0.04 | 0.86 | 0.08 |
| SD | 0.04 | 0.05 | 0.17 | 0.07 |
| n | 9 | 9 | 9 | 9 |

The results show that ethanol, isopropanol and acetone have no antioxidant activity and were similar to that of the blank. Dimethyl sulphoxide (DMSO) showed a mean antioxidant capacity of 0.86 mM Trolox equivalent. Therefore, it is important to test the solvents for antioxidant activity before used for the AIOR assay.

The effect of adding varying amounts of Brij 35 into the working uroporphyrin solution on the standard curve was studied. Two amounts of 20 μL and 100 μL per 15 mL of working uroporphyrin solution were compared. The results showed there was no significant difference in regards to precision and linearity of the standard curve. The correlation coefficient (r) were 0.9878 and 0.9676 for the 20 μL and 100 μL per 15 mL of working uroporphyrin solution respectively. The area under the curve was higher with the 100 μL of Brij 35 solution. The results are summarised in Tables 7 and 8 below.

TABLE 7
20 μL of Briij 35 per 15 mL of working uroporphyrin solution

| Trolox (standard) | Mean Area | | | |
|---|---|---|---|---|
| Concentration | Under Curve | SD | CV (%) | n |
| Blank | 37028 | 1914 | 5.2 | 24 |
| 0.5 mM | 45482 | 1432 | 3.1 | 24 |
| 1.0 mM | 57154 | 2259 | 4.0 | 24 |
| 2.0 mM | 72596 | 1635 | 2.3 | 24 |

TABLE 8
100 μL of Briij 35 per 15 mL of working uroporphyrin solution

| Trolox (standard) | Mean Area | | | |
|---|---|---|---|---|
| Concentration | Under Curve | SD | CV (%) | n |
| Blank | 48861 | 1604 | 3.3 | 24 |
| 0.5 mM | 52714 | 1818 | 3.4 | 24 |
| 1.0 mM | 61482 | 2302 | 3.7 | 24 |
| 2.0 mM | 71394 | 2261 | 3.2 | 24 |

Effect of Choice of 96 well Plates on the AIOR Assay

96-well plates are available in glass, polystyrene and polypropylene. The polystyrene 96-well plates are also available In black, white and transparent texture. In addition, plates also have different shapes at the bottom of the well such as flat, v-shaped and round bottom. The choice of 96-well plate is an important independent factor for the good performance of the AIOR assay. As shown in Table 9, the polypropylene 96-well plate gave the best medium fluorescence intensity with a working uroporphyrin solution of 1/1250 dilution. The glass 96-well plate did not have good fluorescence intensity registered, which resulted in low sensitivity whereas the white polystyrene 96-well plate had too much light reflected which gave a high background. The round bottom polypropylene 96-well plate provided the best shape for mixing on the plate-shaker.

TABLE 9

| | | PMT | Mean | |
|---|---|---|---|---|
| | Uroporphyrin | Voltage | Fluorescence | |
| Type of 96-well plate | Dilution | (V) | Intensity (a.u.) | n |
| Glass | 1/1250 | 660 | 268 ± 42 | 32 |
| Polypropylene | 1/1250 | 700 | 427 ± 15 | 32 |
| Polystyrene (white) | 1/1250 | 660 | 968 ± 19 | 32 |

The alignment of the 96-wellplate in the instrument plays an important role in the precision of the assay. Optimisation of the alignment of the Eclipse is of major priority before embarking on performing of the assay. The polypropylene 96-well plate may be recycled and reuse if washed properly. Generous rinsing with distilled water is required followed by rinsing with ethanol, before another round of generous rinsing with distilled water. The 96-well plate must be completely dried before being used again.

From the 96-wellplate format, an increase to the 384-wellplate format would not be difficult especially with the incorporation of automated dispensing technology.

AIOR Assay Using the Cary Eclipse Fluorescence Spectrophotometer (Varian).

The Cary Eclipse spectrophotometer (Varian) provides a solid backing for the AIOR assay. Photosensitive samples are not exposed to continuous light because the Xenon flash lamp in the Cary Eclipse flashes only to acquire a data point. In addition, the intense Xenon flash lamp, coupled with optimised grating blaze angles and coatings provides good sensitivity across the whole wavelength range and with the Schwarzchild collection optics are well suited for the 96-well plate format fluorescence measurements.

For the Cary Eclipse to perform well, a check list of the instrument is essential. The intensity and stability of the Xenon lamp is important for the smoothness of the curves. The alignment of the 96-well plate is important for the source of light to reach the centre of the well for excitation and emission measurements. The 96-well plate must be level to provide maximum uniformity across the plate—a slight tilt can cause an increase in the imprecision of the assay.

The type of 96-well plate and the elevation of the plate to the light source can cause an increase in unnecessary high background reading. Also, it is important to calibrate the wavelength and the photomultiplier at the beginning after lamp change.

Investigation of Antioxidant Status In a Variety of Beverages

The AIOR assay was used to measure the total antioxidant status of different types of tea, coffee, and chocolate flavoured milk powders, and to compare the antioxidant status between the different beverage types.

Sample Preparation

Samples tested included various brands of tea, coffee and chocolate flavoured milk powders. Tea leaf was weighed and placed in boiling water (100 ml). The coffee was prepared and brewed in the same manner with boiling water for 30 minutes.

Samples were diluted with phosphate buffer (75mM, pH 7.0), unless otherwise specified. A standard amount of 1.87 mg per ml water of coffee, cocoa, Milo® and tea were used for extraction and comparison purposes.

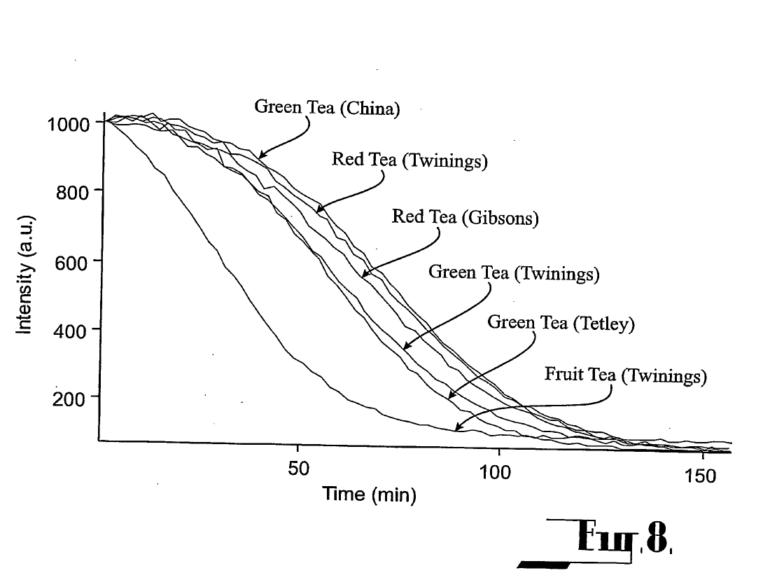

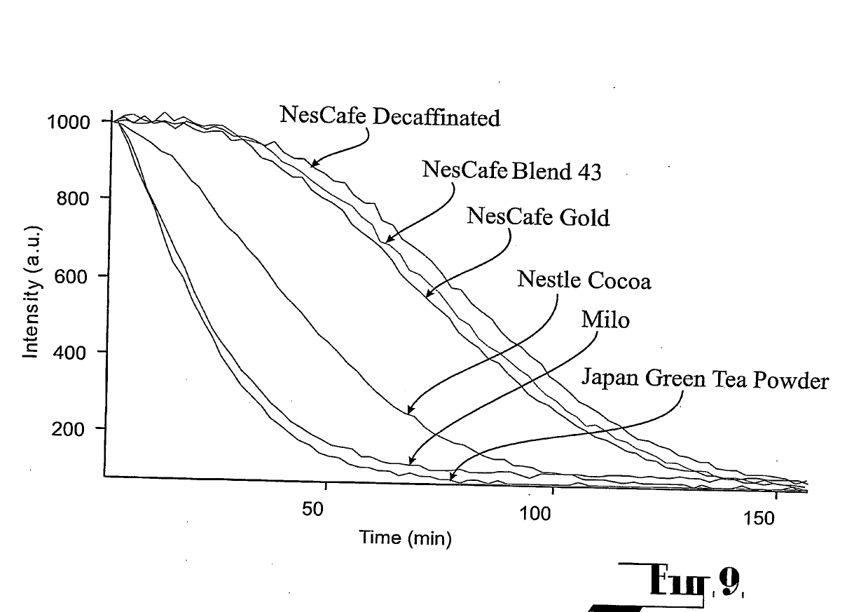

A comparison of the antioxidant status of tea, coffee, and chocolate flavoured powders was made with the antioxidant standard, Trolox. The comparison is expressed as a number relative to Trolox (mM) (see Table 10). A higher number indicates a greater antioxidant status. Each sample (n=24) was analysed using the method as described above, and the coefficient of variation measured (CV%). Graphical representation of the antioxidant status is shown in FIG. 8 (tea) and FIG. 9 (coffee and chocolate milk powders).

These results confirm that the AIOR method is capable of measuring and comparing the total antioxidant status of different types of green and black tea. In addition, the total antioxidant status in Trolox equivalent (mM) of each individual tea is not the same and hence the capacity to moderate oxidative stress will also vary between types of teas.

The important issue of establishing the quality and quantity of the antioxidant status of the tea of which subjects consume during trials and studies has never been addressed. Therefore, it is not surprising that the results of these studies are inconclusive. Subjects may have drunk different types of tea or consumed a different number of cups of tea in the study. With an easier method now available, the antioxidant capacity to moderate oxidative stress in tea consumed both in vitro and in vivo can now be determined.

TABLE 10

| | Trolox | Relative | | |
|---|---|---|---|---|
| | Equivalent | concentration | | |
| Name | (mM) | (mg/ml) | CV (%) | n |
| Gibsons traditional | 3.0 ± 0.2 | 1.87 | 5.0 | 24 |
| full strength tea | | | | |
| Twinings traditional | 3.5 ± 0.1 | 1.87 | 3.8 | 24 |
| afternoon tea | | | | |
| Butterfly Brand | 3.7 ± 0.3 | 1.87 | 6.5 | 24 |
| Fujian China tea | | | | |
| Twinings green tea | 2.8 ± 0.1 | 1.87 | 4.8 | 24 |
| and mint | | | | |
| Tetley Emperor's | 2.7 ± 0.1 | 1.87 | 5.2 | 24 |
| Garden green tea | | | | |
| and peppermint | | | | |
| Twinings | 1.2 ± 0.1 | 1.87 | 10.1 | 24 |
| blackcurrant/apple | | | | |
| Nescafe Blend 43 | 3.5 ± 0.2 | 1.87 | 4.9 | 24 |
| coffee | | | | |
| Nescafe Gold coffee | 3.3 ± 0.1 | 1.87 | 4.3 | 24 |
| Nescafe | 3.6 ± 0.2 | 1.87 | 4.6 | 24 |
| Decaffeinated coffee | | | | |
| Nestle Cocoa | 1.3 ± 0.1 | 1.87 | 6.2 | 24 |
| Milo | 0.4 ± 0.1 | 1.87 | 13.6 | 24 |
| Green tea powder | 0.2 ± 0.1 | 1.87 | 27.0 | 24 |
| Japan | | | | |
| Jacob's Creek | 10.4± | 1.87 | 6.3 | 24 |
| Chardonnay Vintage | | | | |
| 2001 | | | | |
| Wyndham Bin 444 | 34.6± | 1.87 | 4.0 | 24 |
| Cabernet Sauvignon | | | | |
| Vintage 2000 | | | | |

Investigation of Antioxidant Status in Wine

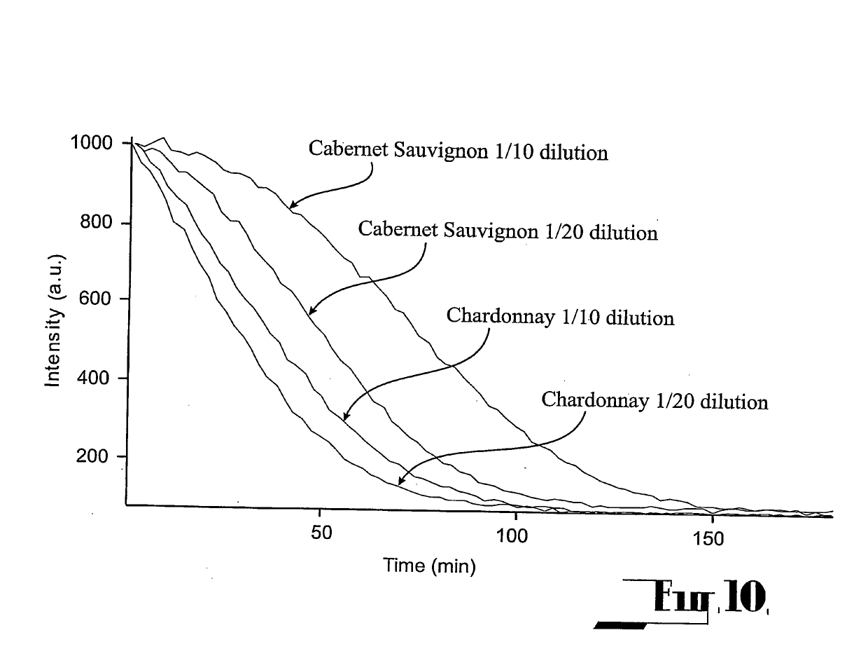

A similar comparison of the antioxidant status of red and white wine with Trolox, was carried out, as outlined above. Wine was diluted to 1:10 or 1:20 (v/v) before analysis. FIG. 10 shows the graphical representation of the results of different types of wine at a 1 in 10 and 1 in 20 dilution. For red and white wine, the mean antioxidant status times the 1/10 dilution factor was 34.6 and 10.4 mM Trolox equivalent respectively, whereas at 1/20, it was 36.3 and 10.9 mM Trolox equivalent respectively. This result showed that red wine has around 2 to 3-fold higher antioxidant status than white wine. The antioxidant status of a variety of wine samples was also measured. Each sample was measured 6 times (see Table 11). It appears from these results that red wine has a greater antioxidant status than white wine.

TABLE 11

| | Antioxidant status | |
|---|---|---|
| | in Trolox | |
| Wine | Equivalent (mM) | CV (%) |
| PEM Cabernet/Merlot | 50.1 ± 1.3 | 2.6 |
| PEM Pinot 1 | 47.0 ± 1.2 | 2.5 |
| MR Cabernet | 46.2 ± 1.2 | 2.6 |
| Wyndham Bin 444 Cabernet | 45.4 ± 1.1 | 2.4 |
| Sauvingnon (2000) | | |
| MR Shiraz | 38.6 ± 0.7 | 1.9 |
| PEM Pinot 2 | 34.7 ± 0.6 | 1.9 |
| Jacob's Creek Chardonnay (2001) | 24.3 ± 4.0 | 16.6 |
| DUNS Chardonnay | 21.9 ± 2.3 | 10.7 |
| MR Chardonnay | 16.5 ± 1.33 | 8.0 |
| PEM Chardonnay | 15.8 ± 1.4 | 8.6 |
| Margaret River Mix | 15.0 ± 1.7 | 11.3 |

The total antioxidant status as measured by the AIOR method gave a good indication of the amount of polyphenol compounds as antioxidants in the wine, which may be directly related to its health benefit. Whether it is the polyphenol compounds ability to act as antioxidants by increasing high-density lipoprotein, reducing LDL oxidation, decreasing platelet aggregation and/or inhibiting PDGF, it is the total antioxidant status which is the marker for the quality of the wine.

Therefore, the application of the AIOR method for measuring antioxidant status and or the capacity to moderate oxidative stress in wine may be very beneficial to the wine industries. For the first time, wine producers may be able to monitor the antioxidant capacity of the wine as an indicator of the polyphenol concentrations in wine and hence the beneficial effect of the wine produced.

Investigation of Antioxidant Status of Grape Juice

Three types of grapes—Shiraz, Cabernet, and Merlot, (285 Kg) each were crushed and the resulting grape juices used to assess the total antioxidant status of the grapes. The total antioxidant status of these grape juices was measured with the AIOR method and the results shown in Table 12.

The results show the total antioxidant status for these different types of grapes was significantly different from each other. Since antioxidant status is directly related to the polyphenol concentration in grapes, wine producers may be able to estimate the antioxidant status of grapes before grapes are being harvested. Also, during fermentation, the total antioxidant status of wine can be monitored to help wine makers to make decisions on the quality of the wine in progress.

TABLE 12

| | Antioxidant Status | | |
|---|---|---|---|
| | in Trolox Equivalent | | |
| Grape variety | (mM ± SD) | CV (%) | n |
| Shiraz | 18.5 ± 2.8 | 15.0 | 10 |
| Cabernet | 25.6 ± 4.7 | 18.5 | 10 |
| Merlot | 30.3 ± 3.5 | 11.7 | 10 |

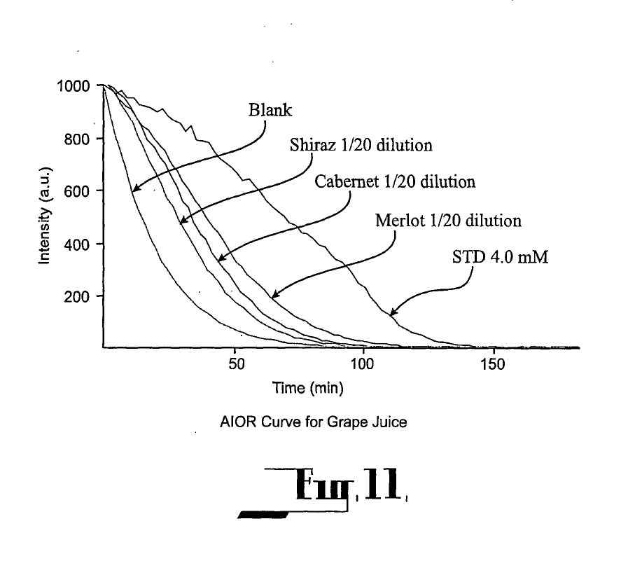

FIG. 11 shows the fluorescence intensity against time of the 1/20 dilution grape juices of the three different types of grapes. The Merlot showed the highest total antioxidant status followed by Cabernet and Shiraz. The blank and standard at 4.0 mM were included to show the relative antioxidant status against the 120 diluted grape juices.

Investigation of Antioxidant Status of Spices

Spices, such as turmeric, have been found by researchers to contain polyphenol compounds. In particular, curcumin was found to have anti-mutagenic and anti-carcinogenic activities, as well as antioxidant status. The AIOR method was used to test the antioxidant status of turmeric and curry powder.

Turmeric and curry powder were weighed and extracted with a solution (1 ml) of ethanol and assay buffer (3:1) at room temperature. The final concentration of the spices was adjusted with buffer to a relative concentration of 1.87 mg/ml of the original weight of the spice powder. This experiment shows that both turmeric and curry powder have a mean total antioxidant status of 2.0 mM Trolox equivalent. Using the AIOR method, it is possible to compare the total antioxidant status of turmeric and curry powder (Table 13) with that of tea, coffee, and chocolate flavoured milk powders (see Table 10)

TABLE 13

| | | Antioxidant Status in | | |
|---|---|---|---|---|
| | Relative | Trolox Equivalent | | |
| Dilution | Concentration | (mM ± SD) | CV (%) | n |
| Turmeric Powder | 1.87 mg/mL | 2.0 ± 0.2 | 7.3 | 12 |
| Neat | | | | |
| Turmeric Powder | 0.94 mg/mL | 1.0 ± 0.1 | 7.5 | 12 |
| ½ Dilution | | | | |
| Curry Powder | 1.87 mg/mL | 2.0 ± 0.3 | 13.9 | 12 |
| Neat | | | | |
| Curry Powder | 0.94 mg/mL | 1.1 ± 0.2 | 15.7 | 12 |
| ½ Dilution | | | | |

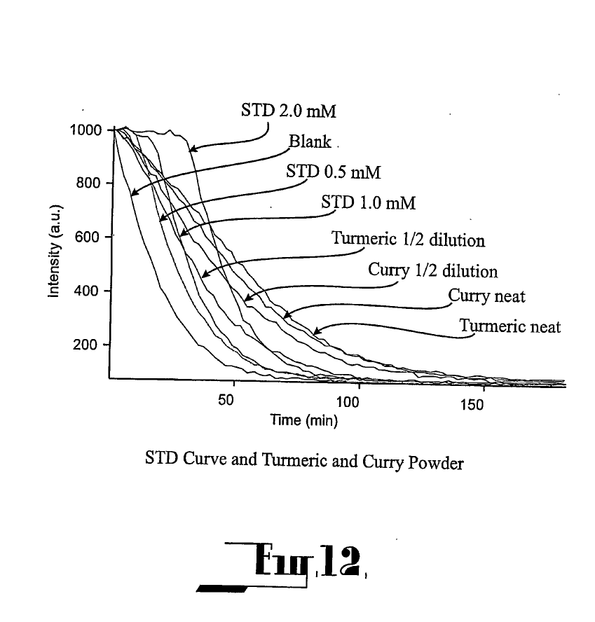

FIG. 12 is a graphical representation of the fluorescence intensity against time for the standards, turmeric and curry powder. The results of dilution of samples showed good agreement with each other.

Investigation of Antioxidant Status of Supplement Tablets

Bioflavonoid dietary supplements are now available in tablet form, such as polyphenol supplements called Rutin and Bioflavonoid tablets, containing rutin (500 mg) plus mixed solubilised bioflavonoid (500 mg) per tablet (Natural Nutrition Company). The AIOR method was used to assess the antioxidant status of this form of supplement.

A tablet (1.40 g) was crushed and ground to a fine powder form. A portion of this powder was weighed (10.4 mg) and extracted with (1.0 ml) of a solvent mixture of isopropanol and water (1:1). The mixture was centrifuged and the supernatant separated. The final concentration of the extract was adjusted with buffer to a relative concentration of 1.87 mg/ml of the original weight of the powder. Further dilution of 1:1, 1:2, 1:3, 1:5, and 1:7 of this solution was made with buffer to check for the linearity of the AIOR method.

The 1.87 mg/ml solution was very high in antioxidant status and above the upper range of the standard curve. An estimated antioxidant status of 6.8 mM Trolox equivalent was calculated from the 1:1 dilution instead. Table 14 shows the results of the different dilutions of the 1.87 mg/ml solution.

TABLE 14

| | Extract | Antioxidant Status in | | |
|---|---|---|---|---|
| Tablet Extract | Concentration | Trolox Equivalent | | |
| (Dilution) | (mg/ml) | (mM ± SD) | CV (%) | n |
| 1:7 | 0.24 | 1.2 ± 0.2 | 12.8 | 12 |
| 1:5 | 0.31 | 1.5 ± 0.2 | 10.1 | 12 |
| 1:3 | 0.47 | 2.2 ± 0.2 | 9.8 | 12 |
| 1:2 | 0.62 | 2.6 ± 0.2 | 6.3 | 12 |

The antioxidant status as Trolox equivalent (mM) of this dilution curve from the 1.87 mg/mL solution showed good linearity with a correlation coefficient (r) of 0.9909. Each tablet was calculated and estimated to have an antioxidant status of about 5100 mM Trolox equivalent. This result showed that the AIOR method could be useful in quality control and labelling of product for antioxidant status such as dietary supplement products.

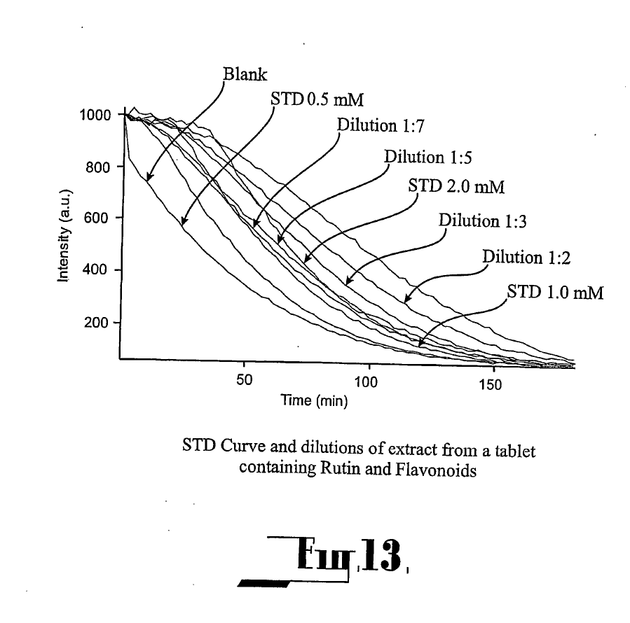

FIG. 13 is a graphical representation of the fluorescence intensity against time for the standards, and the different dilutions of the tablet extract solution.

Investigation of Antioxidant Status of Human Serum

Effect of Preservative on AIOR assay.

Fasting (am) and postprandial (pm) blood samples were collected from two adult middle age male on Day 1 and three days later on Day 2. These samples were collected in serum, EDTA and heparin collection tubes. Table 15 below shows the antioxidant status in mM Trolox equivalent as measured by the AIOR assay. The serum and plasma from these collections were assayed the same day of collection, and also stored either at room temperature overnight or stored at 4° C. for four days before assay. All samples were diligently kept away from direct light at all time during assay or storage.

TABLE 15

| Antioxidant | | | |
|---|---|---|---|
| Status in Trolox | | EDTA | Heparin |
| equivalent (mM) | Serum | Plasma | Plasma |
| Low value | 9.18 | 11.46 | 10.50 |
| High value | 13.68 | 14.10 | 14.82 |
| Mean | 11.81 | 12.88 | 13.19 |
| SD | 1.02 | 0.69 | 0.95 |
| CV (%) | 8.6 | 5.4 | 7.2 |
| n | 72 | 72 | 72 |

The results in this experiment show that serum has the lowest mean antioxidant status in mM Trolox equivalent, compared to plasma treated with either EDTA or heparin. Related paired T test showed that these antioxidant status results are significantly different (p<0.001) from each other. A likely explanation for the higher results in EDTA and heparin plasma is that both EDTA and heparin may have antioxidant activity. In view of this finding, it is important that serum should only be used for the AIOR assay or any other antioxidant status assays.

Sample Stability Diurnal Variation, and Day to Day Variation.

The results in Table 16 shows there is no change in mean antioxidant status in mM Trolox equivalent from the serum samples measured the same day to that of the serum samples stored at room temperature overnight or at 4° C. for 4 days. Unrelated unpaired T test showed no significant difference between these results.

TABLE 16

| | Mean Antioxidant | | | | |
|---|---|---|---|---|---|
| | Capacity in Trolox | Low | High | CV | |
| Serum | Equivalent (mM ± SD) | value | value | (%) | n |
| Assayed the | 12.19 ± 0.83 | 10.32 | 13.68 | 6.8 | 48 |
| same day | | | | | |
| Stored at room | 11.82 ± 0.75 | 10.14 | 13.02 | 6.3 | 24 |
| temperature | | | | | |
| overnight | | | | | |
| Stored at 4° C. for | 11.89 ± 0.96 | 10.26 | 13.50 | 8.1 | 24 |
| 4 days | | | | | |
| Fasting am | 12.17 ± 0.78 | 10.56 | 13.68 | 6.4 | 48 |
| Postprandial pm | 11.88 ± 0.91 | 10.14 | 13.50 | 7.7 | 48 |
| Day 1 (23/05/02) | 12.07 ± 0.82 | 10.14 | 13.68 | 6.8 | 72 |
| Day 2 (27/05/02) | 11.20 ± 0.81 | 9.18 | 13.50 | 7.2 | 47 |

Unrelated unpaired T test of the samples from Day 1 for fasting (am) and postprandial (pm) showed no significant difference in the mean antioxidant status in mM Trolox equivalent. However, there is significant difference (p<0.001) between Day 1 and Day 2 in the mean antioxidant status in mM Trolox equivalent. These results may be interpreted as no significant diurnal changes but significant day to day changes in antioxidant status in serum from individual.

Effect of Deproteinization of Serum.

Total protein in serum is a complex mixture of many different types of protein molecules. Specific protein concentration depends on half-life as well as physiological states. Also, antioxidant status for each type of protein is different. The antioxidant status of plasma is significantly influenced by serum protein not only in terms of quantity, but also in quality. To determine the antioxidant status of different compositions of serum protein mixture is not difficult but the results are hard to interpret because of the many variables such as nutrition status, osmotic pressure, metabolism, catabolism and extracellular body fluid status. For these reasons, the extracellular antioxidant status is best measured without the influence of proteins.

To demonstrate the effect of proteins on antioxidant status, three quality control samples with known amount of total proteins, bilirubin and urate were assayed with or without deproteinization with ethanol. For normal assay, samples were diluted 1:5 with buffer. Deproteinization of samples was done by dilution of sample with ethanol 1:5. The diluted samples were well mixed and kept in the ice bath for 15 minutes. The samples were mixed again before centrifuged for 15 minutes.

The AIOR result of this experiment is shown in the following Table 17. The mean antioxidant status of the three samples diluted with buffer were 26.9, 19.6 and 27.8 mM Trolox equivalent with total protein concentrations of 74, 50 and 63 g/L respectively. With deproteinization, the mean antioxidant status of these samples were 22.0, 11.1 and 19.8 mM Trolox equivalent. The result showed that the mean antioxidant status of the deproteinized samples reflected more accurately the concentrations of the urate and bilirubin in the samples. This result indicated that by deproteinization of serum samples, the total extracellular antioxidant status could be better interpreted.

TABLE 17

| Quality Control Samples | QC 59-11 | QC 59-12 | QC-16 |
|---|---|---|---|
| Albumin (g/L) | 46 | 32 | 40 |
| Total Protein (g/L) | 74 | 50 | 63 |
| Total Bilirubin (μmol/L) | 75 | 33 | 56 |
| Urate (μmol/L) | 590 | 340 | 460 |
| Mean Antioxidant Status in | 26.9 ± 1.9 | 19.6 ± 1.3 | 27.8 ± 2.9 |
| (mM Trolox Equivalent) of | | | |
| Plasma, n = 24 | | | |
| Mean Antioxidant Status in | 22.0 ± 1.6 | 11.1 ± 1.4 | 19.8 ± 2.5 |
| (mM Trolox Equivalent) of | | | |
| Deproteinized sample, n = 24 | | | |

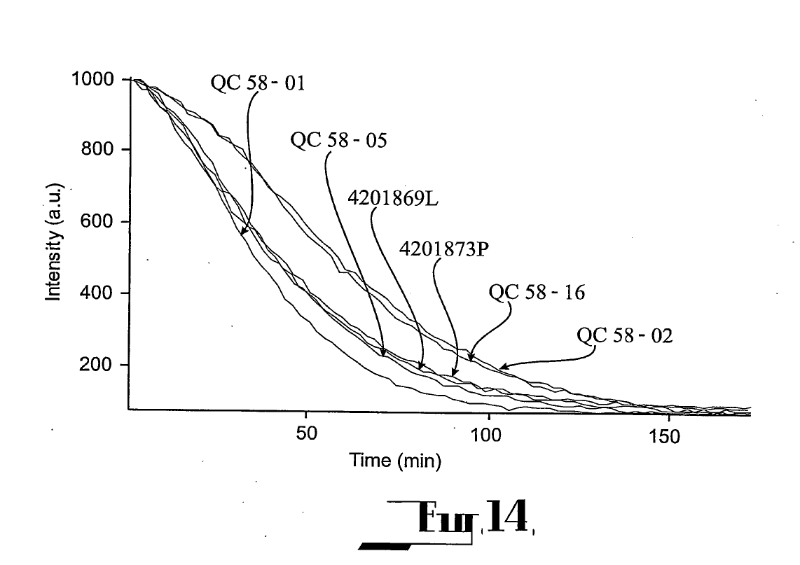

Finally, the antioxidant status compared with Trolox (mM), was measured in serum from human subjects, as described previously. Briefly, serum samples were diluted 1:20 (v/v) before analysis. In addition, the amount of Bilirubin (μmol/L), uric acid (μmol/L), albumin (g/L) and total protein (g/L) were compared to the antioxidant status of the serum samples. The results of this comparison are presented in Table 18. Graphical representation of these results is shown in FIG. 14.

TABLE 18

| | Trolox | | | | Total |
|---|---|---|---|---|---|
| | Equivalent | Bilirubin | Uric acid | Albumin | protein |
| Sample | (mM) | (μmol/L) | (μmol/L) | (g/L) | (g/L) |
| QC 58-01 | 9.1 | 25 | 280 | 28 | 46 |
| QC 58-05 | 11.3 | 37 | 370 | 33 | 53 |
| P4201873P | 11.7 | 4 | 490 | 39 | 81 |
| P4201869L | 11.9 | 8 | 270 | 41 | 79 |
| QC 58-16 | 17.9 | 68 | 600 | 45 | 72 |
| QC 58-02 | 18.6 | 69 | 600 | 43 | 73 |

Investigation of Antioxidant Status in Individual Antioxidants
Uric Acid

Uric acid or urate is often associated with patients with gout. Gout is a metabolic disorder characterised with hyperuricaemia and deposition of urate crystals in tissues. Uric acid is the metabolic end product of a group of compounds call purine which include adenine, guanine, hypoxanthine and xanthine. These are produced via de novo synthesis and salvage pathway of purine metabolism. The overall production rate of urate is 5 to 6 mmol/day on a normal diet. Three to 4 mmol are derived from the de novo route and 1 to 2 mmol from the diet. About one third of the urate is secreted into the gastrointestinal tract where it is destroyed by bacterial uricases. The kidney excretes the remaining two thirds. Physiological adult human uric acid reference range is 200-420 μmol/L for male and 140-340 μmol/L for female. We have shown that uric acid is an important antioxidant in the extracellular compartment using this method and may have a high capacity to moderate oxidative stress. In this experiment uric acid (0.0285 g) was dissolved in phosphate buffer (100 ml) and concentrations at 424, 848 and 1696 μmol/L were obtained. The mean antioxidant status for uric acid at those concentrations were found to be 0.6, 1.2, and 2.4 mM in Trolox equivalent respectively as shown in Table 19.

TABLE 19

| | Antioxidant | | |
|---|---|---|---|
| | Status in | | |
| Uric Acid | Trolox Equivalent | | |
| Concentration | (mM ± SD) | CV (%) | n |
| 424 μM | 0.6 ± 0.1 | 12.3 | 12 |
| 848 μM | 1.2 ± 0.1 | 7.1 | 12 |
| 1696 μM | 2.4 ± 0.1 | 4.7 | 12 |

The correlation between antioxidant status and concentration was good and followed a linear relationship. The Pearson's correlation coefficient r=0.9935, p<0.001. At the physiological upper range for male and female of 420 and 340 μmol/L respectively, an estimation of the mean antioxidant status for uric acid would be 0.59 and 0.48 mM Trolox equivalent, respectively. These results showed that uric acid provides an important background antioxidant status in the extracellular compartment and have a capacity to moderate oxidative stress.

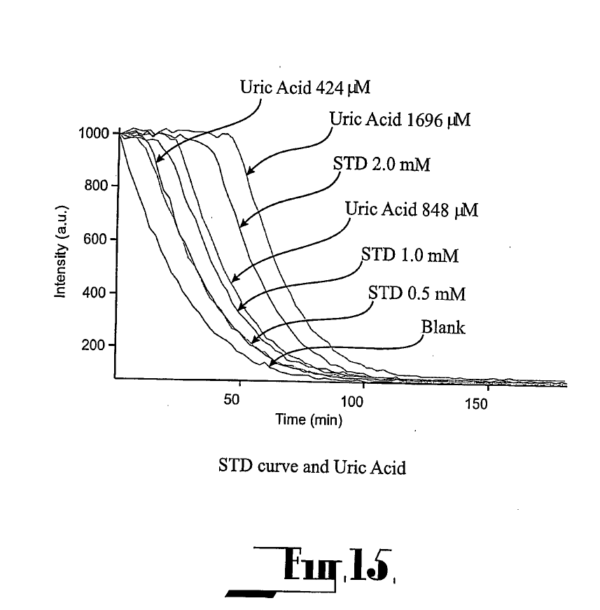

FIG. 15 graphically shows the fluorescence intensity against time for the different concentrations of urate. The urate concentration is directly proportional to the antioxidant status in mM Trolox equivalent, with proportionally larger area under the curve.

Vitamin C.

Physiological adult human vitamin C reference range is around 23-80 μmol/L. However, there is a wide range of concentrations of vitamin C in fruits, vegetables, drinks and supplements in our daily diet. Vitamin C is metabolised very rapidly in vivo. Hence, the real concentration of vitamin C and its antioxidant capacity at any time is very much dependent on the intake of vitamin C at the time.

In this experiment, vitamin C (0.1417 g) was dissolved in deionized water (500 ml) and concentrations at 2650, 5300 and 10600 μmol/L were obtained. The mean antioxidant status for vitamin C at those concentrations were found to be 0.9, 1.8 and 4.0 mM in Trolox equivalent respectively as shown in Table 20.

TABLE 20

| | Antioxidant | | |
|---|---|---|---|
| | Status in | | |
| Vitamin C | Trolox Equivalent | | |
| Concentration | (mM ± SD) | CV (%) | n |
| 2.65 mM | 0.9 ± 0.1 | 12.2 | 12 |
| 5.30 mM | 1.8 ± 0.1 | 8.1 | 12 |
| 10.6 mM | 4.0 ± 0.2 | 4.6 | 12 |

At a concentration range of 2650 to 5300 μmol/L, the antioxidant status for vitamin C showed a linear relationship with concentration. The concentration of 10600 μmol/L was very high and the measured mean antioxidant status of 4.0 mM in Trolox equivalent was way outside that of the standard curve range of 0.0-2.0 mM Trolox equivalent, hence, slight deviation from linearity. The correlation between concentration and antioxidant status was good with the Pearson's correlation coefficient r=0.9933, p<0.001. These concentrations were used to demonstrate that at such high vitamin C concentration, there is also very high antioxidant status and therefore a capacity to moderate oxidative stress.

It is not uncommon to find drinks and supplements with this range of vitamin C concentrations. This is one of the major reasons why the initial antioxidant status of any drinks and supplements should be measured before consumption. After entering the body, however, we need to measure the antioxidant status from the time of absorption to the time of elimination to show that the real antioxidant status is reflected by vitamin C concentration in vivo.

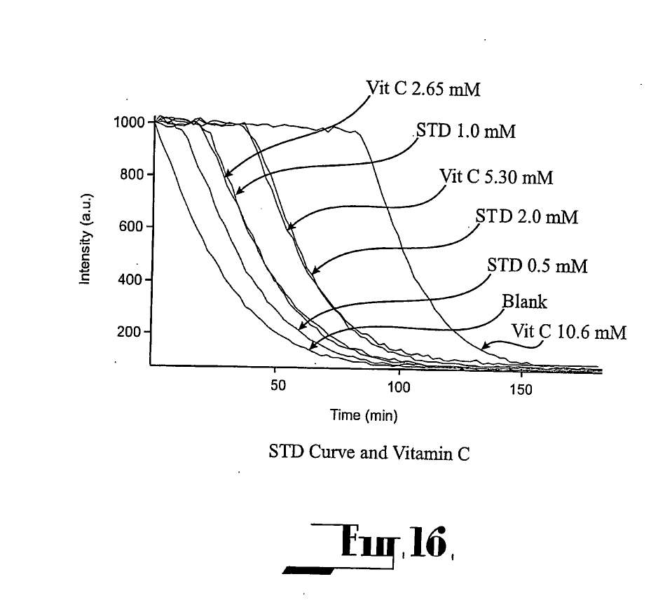

FIG. 16 is a graphical representation of the fluorescence intensity against time for a range of concentrations of vitamin C. The vitamin C concentration is directly proportional to the antioxidant status in mM Trolox equivalent, with proportionally larger area under the curve.

Vitamin A

The physiological reference range for vitamin A of adult human is around 1-4 μmol/L. Vitamin A has been well accepted as one of the antioxidants in vivo at low concentrations, however, in high concentration vitamin A was found to be toxic. A major precursor of vitamin A is β-carotene, the most abundant carotenoid. However, it is estimated that it takes 12 μg of β-carotene to convert in vivo to 1 μg of vitamin A. Excessive consumption of carrot juice, which is rich in β-carotene, may cause a dull yellow orange appearance on palms and soles of hands and feet. The carrot-juice syndrome, however, is generally thought to be harmless and reversible.

In this experiment, vitamin A (0.02224 g) was dissolved in isopropanol (10 ml) and concentrations at 1940, 3880, and 5820 μmol/L were obtained. As shown in Table 21, the AIOR method gave the mean antioxidant status for vitamin A at those concentrations of 0.56, 1.11 and 1.41 mM in Trolox equivalent, respectively. The correlation between antioxidant status and concentration was good with the Pearson's correlation coefficient r=0.9660, p<0.001. The AIOR method illustrated that vitamin A has intrinsic antioxidant property.

TABLE 21

| | Antioxidant | | |
|---|---|---|---|
| | Status in | | |
| Vitamin A | Trolox Equivalent | | |
| Concentration | (mM ± SD) | CV (%) | n |
| 1940 μM | 0.6 ± 0.1 | 15.6 | 10 |
| 3880 μM | 1.1 ± 0.1 | 6.5 | 10 |
| 5820 μM | 1.4 ± 0.1 | 4.7 | 10 |

The fact that such a high concentration of Vitamin A was required to produce significant antioxidant status may explain the reason why researchers are unable to find the link between any antioxidant effect of vitamin A and disease. At such a low physiological concentrations of between 1 to 4 μmol/L, any fluctuation in concentrations is not going to be significantly altering the extracellular antioxidant status and hence in determining the outcome of the disease. There is little point in measuring vitamin A level by itself apart from monitoring of supplement levels to check for deficiency or toxicity. Vitamin A should be measured, as part of the total antioxidant status in vivo and not as an individual free radical scavenger.

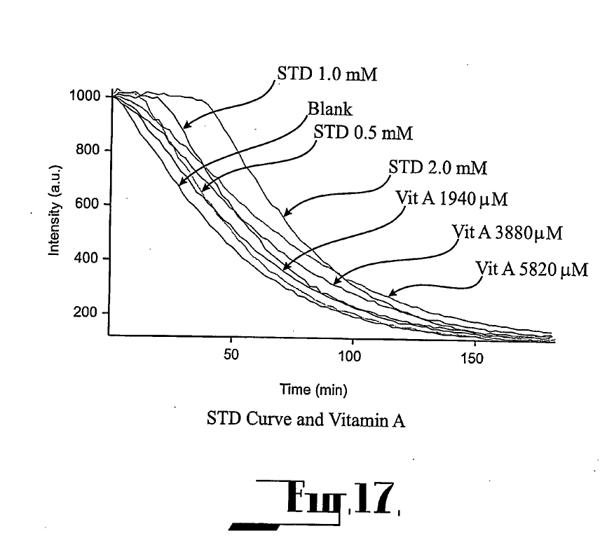

FIG. 17 is a graphical representation showing the fluorescence intensity against time of the varying concentrations of vitamin A. The vitamin A concentration is directly proportional to the antioxidant status in Trolox equivalent, with proportionally larger area under the curve.

Vitamin E

The physiological reference range of vitamin E in adult human is around 18-46 μmol/L. Vitamin E is generally used to describe four tocopherols (α, β, γ and δ) and four tocotrienols unless otherwise specified. In vivo α-Tocopherol is about 15 -40 μmol/L and γ-tocopherol 3-5 μmol/L. An unconfirmed study has suggested that the relative antioxidant capacity of α, γ and δ vitamin E is in the ratio of (1:1.5:3). Vitamin E is present in much higher concentration than vitamin A and δ-carotene.

In this experiment, vitamin E (0.01643 g) was dissolved in isopropanol (10 ml) and concentrations of 952, 1905 and 3810 μmol/L were obtained. The mean antioxidant status for vitamin E at those concentrations were found to be 0.4, 1.1 and 2.7 mM Trolox equivalent, respectively. It is interesting to compare the antioxidant status of vitamin E with Trolox, which is a water-soluble vitamin E derivative. The concentrations of vitamin E in this experiment were about twice that of the Trolox standards, which were 500, 1000, and 2000 μmol/L, but the antioxidant status of vitamin E was all about half that of the Trolox standard. These results (see Table 22) show compounds of similar chemical structure might have very different antioxidant status. The correlation between vitamin E concentration and antioxidant status was good with the Pearson's correlation coefficient r=0.9961, p<0.001.

TABLE 22

| | Antioxidant | | |
|---|---|---|---|
| | Status in | | |
| Vitamin E | Trolox Equivalent | | |
| Concentration | (mM ± SD) | CV (%) | n |
| 952 μM | 0.4 ± 0.1 | 25.4 | 10 |
| 1905 μM | 1.1 ± 0.1 | 5.8 | 10 |
| 3810 μM | 2.7 ± 0.1 | 3.0 | 10 |

It is important to note that vitamin E is lipid-soluble. In plasma and red blood cells, vitamin E is one of the major lipid-soluble antioxidant protecting lipids against peroxidative damage. Hence, the environment in which the antioxidant operates is also an important factor for consideration. It is easy to see that the more diverse the chemical property of all the antioxidants in vivo, the larger the coverage for protection is provided to neutralise the free radicals in vivo. The concentration range used in this experiment was on the high side with the lowest measured concentration to be about 20 times the upper adult reference range. The point, however, was to show that vitamin E was intrinsically an antioxidant capable of neutralising free radical generating substances and therefore has the capacity to moderate oxidative stress.

The result showed that measuring vitamin E alone for antioxidant status might not provide the answer one would hope for. At physiological concentration there is only a low concentration of vitamin E. It is more likely that by measuring the total extracellular antioxidant status, a better picture for the in vivo status could be seen.

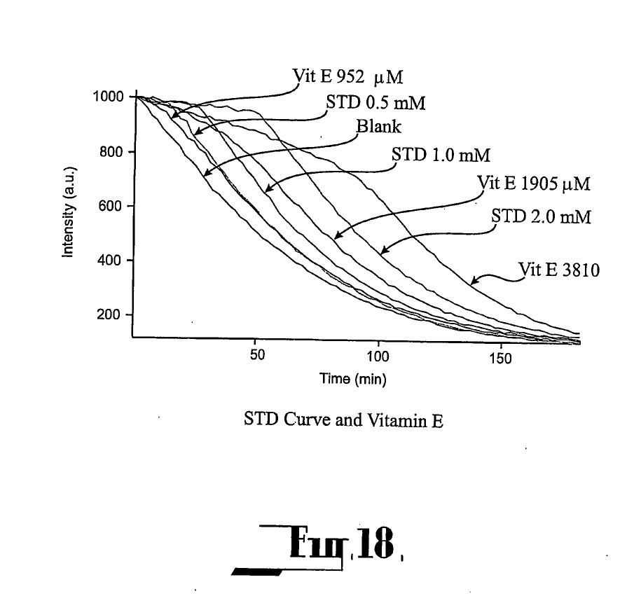

FIG. 18 is a graphical representation showing the fluorescence intensity against time of varying concentrations of vitamin E. The vitamin E concentration is directly proportional to the antioxidant status in Trolox equivalent, with proportionally larger area under the curve.

Caffeine

The controversial effect of caffeine on health is still not decided. Some recent studies implicated that caffeine may affect the action of insulin. Caffeine is present in many popular drinks especially coffee.

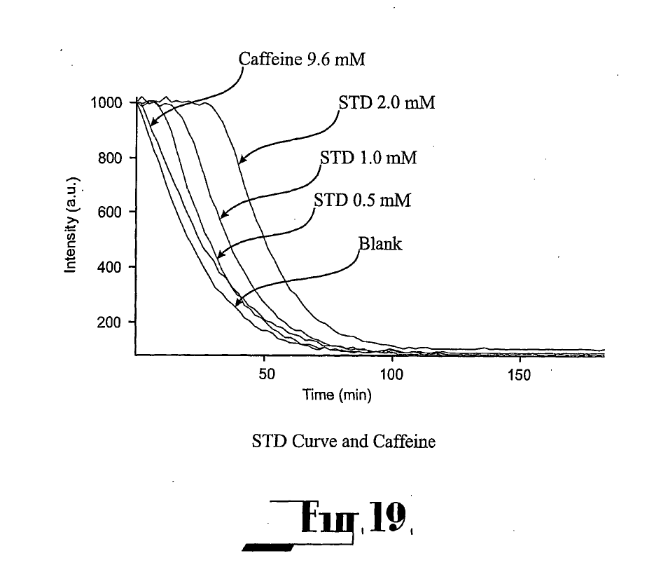

In this experiment, caffeine (0.0468 g) was dissolved in phosphate buffer (25 ml). The mean antioxidant status for caffeine at 9.6 mmol/L was found to be 0.2 mM in Trolox equivalent. Even at such a high concentration, the antioxidant status of caffeine is minimal. This result showed that caffeine does not contribute to the antioxidant status of tea, coffee, cocoa and drinks with added caffeine. FIG. 19 is a graphical representation showing the fluorescence intensity against time for caffeine (9.6 mM) and Trolox standards.

Albumin

Albumin is the predominant contributor to the plasma oncotic pressure and hence plays an important role in controlling the distribution of water between the intra- and extracellular compartments. It is also an important carrier protein for calcium, magnesium, thyroid hormnones, unconjugated bilirubin, fatty acids and some drugs. Less known is its quality as an antioxidant. The physiological adult human albumin reference range is around 35-50 g/L.

Albumin was dissolved in phosphate buffer to give albumin concentrations of 20 and 40 g/L. The mean antioxidant status were measured to be 1.2 and 2.4 mM in Trolox equivalent respectively as shown in Table 23. The antioxidant status had good correlation with concentration and showed linear relationship. The Pearson's correlation coefficient r=0.9882, p<0.001.

TABLE 23

| | Antioxidant | | |
|---|---|---|---|
| | Capacity in | | |
| Albumin | Trolox Equivalent | | |
| Concentration | (mM ± SD) | CV (%) | n |
| 20 g/L | 1.2 ± 0.1 | 9.4 | 12 |
| 40 g/L | 2.4 ± 0.1 | 2.9 | 12 |

As an individual compound, albumin could be the major contributor to the antioxidant status in vivo and therefore have the capacity to moderate oxidative stress. Any change in plasma levels of albumin with or without disease will affect the antioxidant status results dramatically. For example, changes in body fluids, their distribution and amount, losses, change in synthesis and metabolism. These effect would mask the true antioxidant status of the plasma or serum samples measured. To overcome this masking effect, measurement of extracellular antioxidant status of the other antioxidants is preferably performed with deproteinized samples.

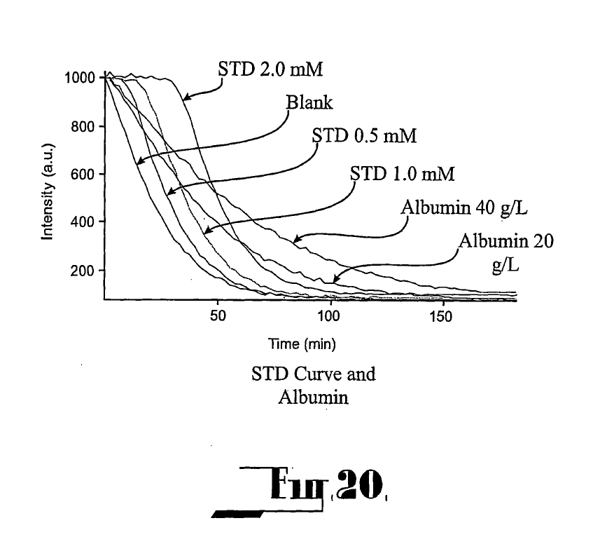

FIG. 20 is a graphical representation showing the fluorescence intensity against time of two concentrations of albumin. The albumin concentration is directly proportional to the antioxidant status in Trolox equivalent, with proportionally larger area under the curve.

Total Protein

There are more than a hundred different proteins in the plasma, the majority of which are enzymes and polypeptide hormones. The physiological adult human total protein reference range is around 60-80 g/L. The structural heterogeneity of plasma proteins is matched by their functional diversity. In this experiment, human serum standard protein from Behring with known concentration (g/L) of all the proteins in solution was used to measure the mean antioxidant status in Trolox equivalent (mM). The total protein concentration was 64.8 g/L. Albumin was the major contributor with 41.5 g/L followed by IgG with 11.0 g/L.

The mean antioxidant status in mM Trolox equivalent for total protein at 32.4, 43.2 and 64.8 g/L are shown in Table 24.

TABLE 24

| | Antioxidant | | |
|---|---|---|---|
| | Status in | | |
| Total Protein | Trolox Equivalent | | |
| Concentration | (mM ± SD) | CV (%) | n |
| 32.4 g/L | 1.1 ± 0.1 | 12.4 | 20 |
| 43.2 g/L | 2.0 ± 0.2 | 12.0 | 20 |
| 64.8 g/L | 3.3 ± 0.2 | 4.9 | 20 |

As shown in Table 24, the mean antioxidant status for total protein at a concentration of 32.4, 43.2, 64.8 g/L were 1.1, 2.0 and 3.3 mM Trolox equivalent, respectively. The antioxidant status for total protein showed reasonable linear relationship given that there were many different types of protein with diverse properties in the mixture. The correlation between concentration and antioxidant status was good. The Pearson's correlation coefficient r=0.9770, p<0.001.

This data was compared with that of albumin, which previously showed that at a concentration of 20 and 40 g/L, the mean antioxidant status were 1.2 and 2.4 mM in Trolox equivalent respectively. The proportion of albumin in the total protein mixture of 32.4, 43.2, 64.8 g/L, were 20.8, 27.7, and 41.5 g/L, respectively. A large proportion of antioxidant status came from the albumin fraction. At a total protein concentration of 32.4 g/L, there was about 20.8 g/L of albumin and a mean antioxidant status of 1.1 mM in Trolox equivalent. This was comparable to the mean antioxidant status of 1.2 mM in Trolox equivalent of albumin alone at a concentration of 20 g/L. At the total protein concentration of 64.8 g/L, there was about 41.5 g/L of albumin with a mean antioxidant status of 3.3 mM in Trolox equivalent. Again albumin at 40 g/L was shown to have a mean antioxidant status of 2.4 mM in Trolox equivalent. It is clear that the remaining proteins made up the rest of the antioxidant status in the total protein mixture although this was not obvious in the more diluted mixture.

The observation in here has important implication in the measurement of antioxidant capacity in plasma and serum as shown with albumin. These results suggested that the effect of albumin and total protein might mask the contribution to extracellular antioxidant status of the other antioxidants, which are at much lower concentrations relatively.

Plasma proteins are involved in intra-vascular transport, inflammatory response and immunological defence, control of extracellular fluid distribution, blood clotting and fibrinolytic cascade, nutrition, tissue and cell structure and repair and many more. Any of these changes could affect the total antioxidant status results for the wrong reason. It is therefore important to take into consideration the deproteinization of plasma or serum before measurement of extracellular antioxidant status.

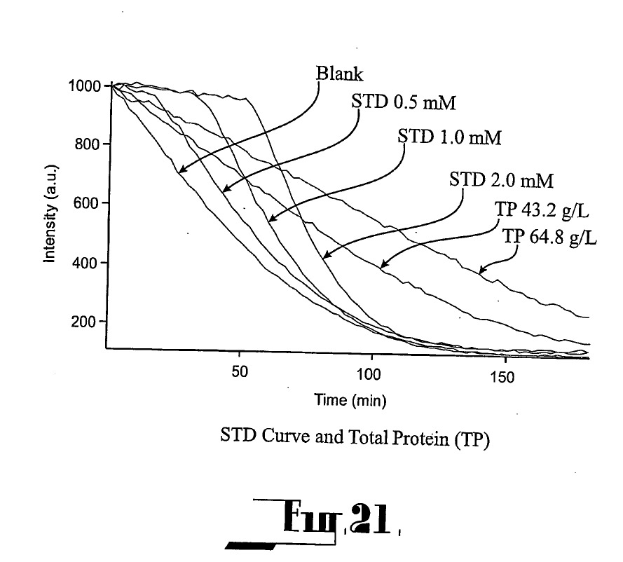

FIG. 21 is a graphical representation showing the fluorescence intensity against time of the different concentrations of total protein. The total protein concentration is directly proportional to the antioxidant status in Trolox equivalent, with proportionally larger area under the curve.

Polyphenols

One of the many natural products from plants are polyphenol compounds. Many researches are now focusing on the anti-mutagenic, anti- carcinogenic and antioxidant capacity of this class of compounds. Chemically, polyphenol compounds may be subdivided into two categories, the flavonoid polyphenol compounds such as rutin, catechin, quercetin, myricetin and apigenin and non-flavonoid polyphenol compounds such as hydroquinone, gallic acid, chlorogenic acid, and 1,2,3-trihydroxybenzene. There are many polyphenol compounds and each polyphenol has its own pharmacological properties. However, all polyphenol compounds have in common their antioxidant capacity. The chemical structures of polyphenol compounds play an important part in determining the potency of their antioxidant capacity. Ranking of polyphenol compounds according to their antioxidant capacity is seldom mentioned mainly due to the lack of good methods to measure the antioxidant capacity of these compounds. The AIOR method as shown in here is well suited for this task.

Rutin, quercetin, (−) epicatechin, (±) catechin and gallic acid were dissolved in ethanol (1 ml). Dilutions were made with ethanol to give concentration of 0.5 mM and 0.25 mM for each of the compound. The antioxidant capacity results of the five polyphenol compounds, quercetin, (−) epicatechin, (±) catechin, rutin and gallic acid at 0.5mM and 0.25 mM are summarised in Tables 25 and 26, respectively.

Quercetin showed the highest antioxidant status amongst the five polyphenol compounds and gallic acid the lowest compared to the other polyphenol compounds. The results showed that (−) epicatechin and (±) catechin at the same concentrations showed different antioxidant status and distinctly different from rutin. The antioxidant status for (−) epicatechin was relatively higher than that of (±) catechin.

TABLE 25

| | | Antioxidant Status | | |
|---|---|---|---|---|
| | Concentration | Trolox Equivalent | | |
| Polyphenol | (mM) | (mM ± SD) | CV (%) | n |
| Quercetin | 0.5 | 4.58 ± 0.24 | 5.3 | 12 |
| (−) Epicatechin | 0.5 | 3.69 ± 0.23 | 6.2 | 12 |
| (±) Catechin | 0.5 | 3.47 ± 0.19 | 5.4 | 12 |
| Rutin | 0.5 | 3.39 ± 0.40 | 11.7 | 12 |
| Gallic acid | 0.5 | 1.22 ± 0.17 | 14.3 | 12 |

TABLE 26

| | | Antioxidant Status | | |
|---|---|---|---|---|
| | Concentration | Trolox Equivalent | | |
| Polyphenol | (mM) | (mM ± SD) | CV (%) | n |
| Quercetin | 0.25 | 1.82 ± 0.13 | 7.3 | 12 |
| (−) Epicatechin | 0.25 | 1.62 ± 0.13 | 8.0 | 12 |
| (±) Catechin | 0.25 | 1.60 ± 0.07 | 4.6 | 12 |
| Rutin | 0.25 | 1.58 ± 0.09 | 6.0 | 12 |
| Gallic acid | 0.25 | 0.46 ± 0.07 | 14.5 | 9 |

Polyphenol compounds occur as glycoside conjugates as well as in the free form in the plants. The final concentrations of polyphenol compounds in the blood from the consumption of fruits and vegetables has to take into account the absorption, distribution and metabolism of these compounds. In other words, bioavailability of polyphenol compounds for antioxidant activity in vivo has to be measured after consumption. Diet history of polyphenol consumption is inadequate in the assessment of blood polyphenol concentrations. Trials correlating the beneficial effect of tea, wine and other supplements are meaningless without measurement of both in vitro and in vivo antioxidant status. The health beneficial effect results from correlation study between the antioxidant status of polyphenol compounds against free radical generating substances have to be measured in solid terms.

Because of the diversity and labile concentrations of polyphenol compounds in vivo, it is important to know if the antioxidant status effect of a polyphenol is cumulative. The AIOR result of this experiment showed that the antioxidant status effect of polyphenol compounds is cumulative as summarised in Table 27 below.

The result showed that with rutin, quercetin, (−) epicatechin and gallic acid, the calculated and observed antioxidant status of a mixture of these four polyphenol compounds at 1/16 dilution is very close. The calculated antioxidant status was 3.50 mM Trolox equivalent compared to that of the observed antioxidant status of 3.93±0.21 mM Trolox equivalent (n=12). This result positively indicated that the antioxidant status of polyphenol compounds is cumulative.

TABLE 27

| | Antioxidant Status | Antioxidant Status |
|---|---|---|
| | Trolox Equivalent | (mM) Trolox |
| | (mM) of the observed | Equivalent |
| | individual | Calculated 1/16 |
| Polyphenols | ¼ Dilution | Dilution) |
| Rutin (n = 9) | 3.79 ± 0.25 | 0.95 |
| Quercetin (n = 9) | 4.41 ± 0.44 | 1.10 |
| (−)-Epicatechin (n = 9) | 4.03 ± 0.28 | 1.00 |
| Gallic acid (n = 9) | 1.75 ± 0.11 | 0.45 |
| Calculated Antioxidant | 14.0 | 3.50 |
| Capacity (AOC) | | |
| of the 4 Polyphenols | | |
| together in total | | |
| Observed Antioxidant | — | 3.93 ± 0.21 |
| Capacity (AOC) of | | (n = 12) |
| mixture of 4 Polyphenols | | |
| in 1/16 Dilution | | |

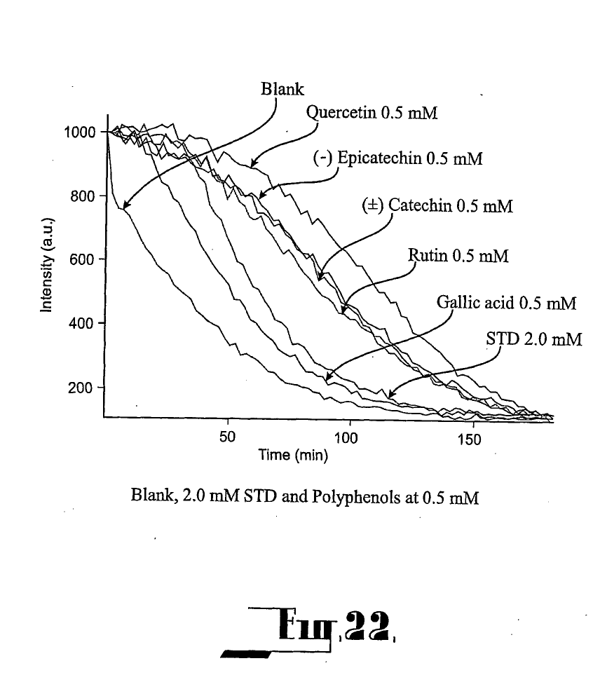

FIG. 22 is a graphical representation showing the fluorescence intensity against time of the different polyphenol compounds: rutin (0.44 mM), quercetin (0.38 mM), (−)-epicatechin (0.44 mM) and gallic acid (0.57 mM) and a mixture of these polyphenols at the same concentrations. The mixture of polyphenol compounds showed proportionally larger area under the curve is directly proportional to the antioxidant status in mM Trolox equivalent.

1. A method of measuring antioxidant status and/or the capacity to moderate oxidative stress in a sample including the step of contacting the sample with at least a fluorescing porphyrin compound.

2. A method of measuring antioxidant status and/or the capacity to moderate oxidative stress in a sample including the step of contacting the sample with at least afluorescing porphyrin compound under conditions suitable for measuring the antioxidant status and/or the capacity to moderate oxidative stress in the sample.

3. A method according to claim 1 wherein the porphyrin compound is selected from the group consisting of uroporphyrin I, uroporphyrin II, uroporphyrin III, uroporphyrin IV, coproporphyrin I, coproporphyrin II, coproporphyin III, coproporphyrin IV, MS-tetraphenylporphyrin, deuteroporphyrin IX, hematoporphyrin IX, mesoporphyrin, protoporphyrin IX, and dihydrochloride and methyl ester derivatives of all the above mentioned porphyrins.

4. A method according to claim 1 wherein the porphyrin compound is of a uroporphyrin structure.

5. A method according to claim 1 wherein the porphyrin compound is uroporphyrin I dihydrochloride.

6. A method of measuring antioxidant status and/or the capacity to moderate oxidative stress in a sample, comprising the steps of:
a. contacting the sample with at least a free radical generating substance and afluorescing porphyrin compound; and
b. determining the antioxidant status and/or the capacity to moderate oxidative stress of the sample by measuring the resultant fluorescence of the mixture in step (a), and comparing the fluorescence to a standard.

7. A method according to claim 6 wherein the free radical generating substance is selected from the groups consisting of: peroxidase/H₂O, horseradishperoxidase/H₂O₂, and amidino-azo-radical initiators.

8. A method according to claim 6 wherein the free radical generating substance is 2,2′-azobis(2-methylpropionamidine)dihydrochloride.

9. A method according to claim 6 wherein in addition to contacting the sample in step (a) with a free radical generating substance and afluorescing porphyrin compound the sample is also contacted with at least a surfactant, emulsifier or solubilizer.

10. A method according to claim 9 wherein the surfactant is a polyoxyethylene alcohol.

11. A method according to claim 10 wherein the polyoxyethylene alcohol is a polyoxyethylene ether.

12. A method according to claim 1 wherein degradation of the porphyrin compound is measured by spectrofluorometer.

13. A kit for determining the antioxidant status and/or the capacity to moderate oxidative stress of a sample, comprising a free radical generating substance, a fluorescing porphyrin compound and instructions for their use in accordance with the method as claimed in claim 1.

14. A method according to claim 6 wherein degradation of the porphyrin compound is measured by spectrofluorometer.

15. A kit for determining the antioxidant status and/or the capacity to moderate oxidative stress of a sample, comprising a free radical generating substance, a fluorescing porphyrin compound and instructions for their use in accordance with the method as claimed in claim 6.
